(19) United States
(12) Patent Application Publication
(10) Pub. No.: US 2017/0260340 A1
(43) Pub. Date: Sep. 14, 2017

(54) STYRENE-BUTADIENE RUBBER (SBR)-NANOCARBON FILLED MASTERBATCHES AND USES THEREOF

(71) Applicant: AMRIL AG, Zug (CH)

(72) Inventors: Surina Ismail, Kuala Lumpur (MY); Azemi Samsuri, Selangor (MY)

(73) Assignee: AMRIL AG, Zug (CH)

(21) Appl. No.: 15/504,415

(22) PCT Filed: Sep. 8, 2015
(86) PCT No.: PCT/EP2015/070516

§ 371 Date: Feb. 16, 2017

(30) Foreign Application Priority Data
Sep. 25, 2014 (GB) 1416886.8

(51) Int. Cl. C08J 3/215; C08J 3/16; C08J 3/22; C08K 3/04

(52) U.S. Cl. CPC C08J 3/215; C08K 3/041; C08J 3/16; C08J 3/226; C08K 3/04; C08K 2201/011; C08J 2309/08; C08J 2409/08; C08K 2201/001

(57) ABSTRACT

The present invention relates to the use of nanocarbon (carbon nanotubes and/or carbon nanofibers) in the preparation of reinforced (filled) styrene-butadiene rubber (SBR). Furthermore, the present invention relates to a method of preparing reinforced SBR master batches having nanocarbon as reinforcing agent wherein the nanocarbon is uniformly predispersed within the SBR, as well reinforced rubber compositions containing said reinforced SBR which have nanocarbon and carbon black as reinforcing agents, and to uses thereof.

### FIELD OF THE INVENTION

The present invention relates to the use of nano-sized carbon structures (nanocarbon) in the preparation of reinforced (filled) styrene-butadiene rubber (SBR). More particularly, the present invention relates to a method of preparing reinforced SBR master batches with nanocarbon as a reinforcing agent wherein the nanocarbon is uniformly pre-dispersed within the SBR, as well as reinforced rubber compositions containing said reinforced SBR with nanocarbon and carbon black as reinforcing agents, and to uses thereof.

### TECHNICAL BACKGROUND

Styrene-butadiene rubber (SBR) is a synthetic rubber derived from styrene and butadiene. SBR has varied industrial applications ranging from use of SBR elastomers in chewing gum and adhesives to incorporation of SBR in rubber products including pneumatic automotive and truck tires, hoses, shoes, and conveyor belts. Presently about 50% of automotive tires are made from SBR, where it has particular utility in the manufacture of tires having low rolling resistance. Whilst SBR does have some inherent processing advantages versus natural rubber, as well as certain technical features such as heat aging and abrasion resistance, it is generally accepted that SBR has poorer elongation, hysteresis resilience/rolling resistance and tensile strength versus natural rubber. Thus it would be desirable to provide SBR improved master batches having improved performance in one or more of tensile strength, hysteresis resilience and/or elongation. It would also be desirable to provide rubber compositions which include such improved SBR master batches, where such rubber compositions also demonstrate improved performance in one or more of tensile strength, hysteresis resilience and/or elongation.

Following the discovery of nano-sized carbon materials, also known as nano-sized carbon structures, or nanocarbons including the carbon allotrope graphene, as well as structures based on graphene such carbon nanotubes (CNTs) which are also carbon allotropes and are sometimes referred to as buckytubes, and/or carbon nanofibers (CNFs), and their unique combination of extraordinary strength, for example tensile strength greater than steel but with only one sixth of its weight, there has been great interest in using such materials. For example, carbon nanotubes (CNTs) have been used as reinforcing agents in polymer structures.

CNTs are allotropes of carbon which have a unique atomic structure consisting of covalently bonded carbon atoms arranged in long cylinders with typical diameters in the range of 1 to 50 nm and a wide variety of lengths (Rubber Nanocomposites: Preparation, Properties and Applications; edited by Sabu Thomas and Ranimol Stephen, John Wiley & Sons, 2010). Based on the fast growing knowledge about their physical and chemical properties, nanosized carbon structures such as carbon nanotubes or carbon nanofibers (CNT or CNF) have found a wide range of industrial applications including field effect transistors, one-dimensional quantum wires, field emitters and hydrogen storage. Individual carbon nanotubes are characterized by a high aspect ratio (300 to 1000), high flexibility and unique combination of mechanical, electrical and thermal properties.

The combination of these properties along with a very low mass density makes them potentially useful as ideal reinforcing fibers for high-performance polymer composites. It has also been postulated that CNTs may have greater affinity, and therefore potential to improve strength, in unsaturated hydrocarbon-based polymer matrices, rather than saturated systems. Early studies by Qian et. al., Applied Physics Letters, 2000: 76(20), p. 2868-2870 confirmed that addition of relatively low amounts of CNTs to an unsaturated polystyrene polymer matrix led to significant improvements in tensile strength and stiffness. Such reports have contributed to the desire to incorporate CNTs into other polymer systems.

Whilst there are numerous academic publications postulating that nanocarbon, including CNTs may have utility as reinforcing agents in polymer systems, in reality the widespread use of nanocarbon, and CNTs in particular as reinforcements of polymer matrices has been held back by the difficulty in achieving a good dispersion in the composite, independent of filler shape and aspect ratio. Unless uniform dispersion of nanocarbon within the polymer matrix is obtained, enhancement in mechanical strength and other relevant physical properties is not achieved. Direct incorporation of nanocarbon materials into dry nitrile rubber cannot be achieved through conventional mixing processes like those used for commonly used reinforcing agents/fillers such as for example, the incorporation of carbon black.

Carbon black is well known for use as a reinforcing agent, or filler, to improve the tensile strength and mechanical properties of rubber products. However, as reported by Carretero-Gonzalez et al., “Effect of Nanoclay on Natural Rubber Microstructure”, Macromolecules, 41 (2008), p 6763, use of large amounts of such mineral fillers can lead to heavy final products and replacement with nanoparticles may have advantages for filler distribution within the rubber. Thus it would be desirable to provide SBR compositions reinforced with both nanocarbon and carbon black wherein said compositions have comparable or improved physical or mechanical properties.

Most reports and publications concerning nanoparticulate fillers for polymers relate to thermoplastics, but almost none to dry rubber.

Rubbers are inherently very viscous materials. It is a considerably difficult task to disperse a very light material such as nanocarbon, especially when in particulate form, into a very viscous medium, such as for example natural rubber, styrene-butadiene rubber (SBR) or other similar elastomers.

The main reason is that it is more difficult to mix nanoparticulate fillers into rubber than into thermoplastics since the former is a much more viscous material than the latter because the molecular weight of rubber is substantially higher than that of thermoplastics. The most important aspect of mixing is the final dispersion of the filler in the rubber matrix.

Carbon nanotubes as usually supplied consist largely of aggregates, but reinforcement comes from individual particles. Intercalation and exfoliation denote CNT dispersion and interaction with the polymer matrix, respectively. If intercalation and exfoliation are not attained during mixing, the final outcome is very poor mechanical strength. Thus it would be desirable to provide a method of preparing nanocarbon-reinforced SBR having both the physical properties and mechanical strength for commercial utility.

Mixing of CNTs with SBR using conventional methodology cannot produce master batches or rubber compositions having the desired physical properties and mechanical strength for commercial utility. It is generally accepted that the root cause of this problem is associated with the poor dispersion of nanocarbon in the SBR matrix due to the high viscosity of the rubber, and it is also accepted that conventional mixing equipment, as is typically used in the rubber industry, such as 2-roll mills, kneaders and internal mixers or even twin screw extruders, are not able to provide efficient dispersions of nanocarbon within an SBR (rubber) matrix.

Thus it would be highly desirable to develop a method for the preparation of nanocarbon-reinforced SBR master batches, and particularly CNT-reinforced SBR master batches, wherein the nanocarbon or the CNT is uniformly dispersed within the SBR matrix. It would be especially advantageous to provide an optimized, simpler, more efficient method for preparing such nanocarbon reinforced SBR master batches, and particularly a method where such dispersion is achieved using conventional mixing equipment used in the rubber industry.

Chinese patent application CN 1663991 A describes a powder natural rubber modified by CNTs and a method of preparing the same. Said powder natural rubber is characterized in that the mass ratio of CNTs to dried rubber of natural rubber latex is in the range from 1% to 50%. The method of preparing the modified rubber requires that the CNTs are subjected to an acid treatment to make them hydrophilic. The method further comprises the steps of mixing the treated CNTs with a dispersant and deionized water to form a CNT/water slurry; modifying the pH value of the slurry to 9 to 12; mixing the slurry with natural rubber latex to form a natural rubber liquid latex added with CNTs; and spray-drying the latex to obtain the powder natural rubber modified with CNTs.

Chinese patent application CN 1673261 A describes a natural rubber liquid slurry added with carbon nanotubes characterized in that the total solid contents of CNTs and the dried rubber of the natural rubber latex is in the range from 5% to 30% and a method for preparing such a natural rubber liquid slurry, characterized in that the method comprises the steps of (i) surface treating CNTs such that they become hydrophilic; (ii) mixing the CNTs with dispersant and deionized water to obtain a CNT/water suspension, wherein the mass ratio of dispersant to the said CNTs is in the range from 5% to 20%; (iii) adjusting the pH of the suspension to 9 to 12; and (iv) homogenously mixing the pH adjusted CNT/water suspension with natural rubber latex to obtain a natural rubber liquid slurry with added CNTs.

It is an object of at least one aspect of the present invention to obviate or mitigate at least one or more of the aforementioned problems.

It is an object of at least one aspect of the present invention to provide a solution to overcome the significant problems associated with the provision of particulate-reinforced high viscosity of dry SBR rubber. It is a particular object of at least one further aspect of the present invention to provide a solution to overcome the agglomeration and poor dispersion issues associated with incorporation of nanocarbon, and CNT in particular, into SBR. It is also an object of another aspect of the present invention to provide a solution to the physical and mechanical deficiencies associated with incorporation of nanocarbon into SBR, especially poor mechanical strength.

It is a further object of at least one aspect the present invention to provide nanocarbon reinforced SBR compositions, or master batches, which have improved physical and mechanical properties, such as improved hardness, improved modulus and/or improved tensile strength, and a method for the preparation of such nanocarbon-reinforced compositions/master batches.

It is a yet further object of at least one aspect of the present invention to provide SBR compositions which comprise nanocarbon-reinforced SBR, which compositions are reinforced with nanocarbon and carbon black, and which have improved physical and mechanical properties, such as improved hardness, improved modulus and/or improved tensile strength.

It is an object of at least one additional aspect of the present invention to provide improved nanocarbon-reinforced SBR compositions for use in rubber compounds or products having nanocarbon and carbon black as reinforcing agents.

It is an object of at least one further aspect of the present invention to provide a nanocarbon-reinforced SBR composition that has or results in improved physical and mechanical properties which is suitable for commercial utility including: use in the manufacture of one or more articles independently selected from: car or light truck tires; truck tire tread compounds; automotive floor mats; brake and clutch pads; footwear such as soles and heels for footwear; domestic and commercial products including floor mats, conveyor belts, garden and industrial hosing, insulation and jacketing for electrical cables; use in foodstuffs including food packaging.

### SUMMARY OF THE INVENTION

In order to achieve these objects, the Applicants have developed novel nanocarbon-reinforced SBR masterbatch compositions, wherein the so-reinforced SBR compositions have improved physical and mechanical properties, and also a method for the preparation of nanocarbon-reinforced SBR master batches, and particularly CNT-reinforced SBR master batches. The Applicants have also developed a method for the preparation of rubber compositions comprising said reinforced SBR master batches.

According to an aspect the present invention provides a nanocarbon-reinforced SBR rubber masterbatch composition comprising less than 5 pphr of nanocarbon (relative amount in parts by weight per hundred parts by weight of SBR), wherein the nanocarbon has not been subjected to an acid treatment before incorporation into the rubber composition, wherein the composition is a liquid composition obtained by combining a liquid dispersion of the nanocarbon and SBR in the form of a latex, and wherein the combined nanocarbon dispersion and SBR latex mixture is masticated.

According to another aspect the present invention provides a nanocarbon-reinforced styrene-butadiene rubber masterbatch composition (an SBR masterbatch) comprising 5 pphr or less (parts by weight per hundred parts by weight of SBR) of nanocarbon, wherein the nanocarbon has not been subjected to an acid treatment before incorporation into the SBR, wherein the composition is a liquid composition obtained by combining a liquid dispersion of the nanocarbon and the SBR, wherein the SBR is in the form of a latex having an solid content of from 40% to 50%, and wherein the composition is masticated either before or after the addition of an aqueous nanocarbon dispersion to the SBR latex.

According to a further aspect the present invention provides a method of making a nanocarbon-reinforced SBR masterbatch composition wherein the method comprises the following steps:
(i) providing a dispersion of nanocarbon in a aqueous medium, wherein the aqueous medium optionally comprises one or more surfactants;
(ii) providing a styrene butadiene rubber latex, (SBR latex);
(iii) combining the aqueous dispersion of nanocarbon with the SBR latex to provide a liquid composition;
(iv) mixing on a 2-roll mill or in an internal mixer to provide a nanocarbon-reinforced SBR masterbatch;
(v) addition of one or more optional masticating agents and mastication in SBR-latex-containing stage (ii) or (iii);
   wherein the nanocarbon is not subjected to an acid treatment before incorporation into the composition, and wherein the nanocarbon-reinforced SBR masterbatch composition comprises less than 5 pphr of nanocarbon, relative amount in parts by weight per hundred parts by weight of SBR.

According to a further aspect the present invention provides a method of making a nanocarbon-reinforced SBR masterbatch composition wherein the method comprises the following steps:
(i) providing a dispersion of nanocarbon in a aqueous medium, wherein the aqueous medium optionally comprises one or more surfactants;
(ii) providing a styrene butadiene rubber latex, (SBR latex);
(iii) combining the aqueous dispersion of nanocarbon with the styrene butadiene rubber latex, (SBR latex) to provide a liquid composition;
(iv) mixing on a 2-roll mill or in an internal mixer to provide a nanocarbon-reinforced SBR masterbatch;
(v) addition of one or more masticating agents and mastication in SBR-latex-containing stage (ii) or (iii);
   wherein the nanocarbon is not subjected to an acid treatment before incorporation into the composition, and wherein the nanocarbon-reinforced SBR masterbatch composition comprises less than 5 pphr of nanocarbon, relative amount in parts by weight per hundred parts by weight of SBR.

According to a further aspect the present invention provides a rubber composition, or rubber compound, which includes nanocarbon-reinforced styrene-butadiene rubber (SBR) composition, wherein said composition comprises a mixture of SBR, nanocarbon and carbon black, wherein the relative amount in parts by weight per hundred parts by weight of SBR (SBR-pphr) of nanocarbon to carbon black is in the range of about 1:100 to about 1:9, wherein the relative amount in SBR-pphr of nanocarbon to SBR is in the range of about 0.5:100 to about 2.5:100, wherein the nanocarbon component is pre-dispersed within at least a portion of the SBR component and wherein the nanocarbon has not been subjected to an acid treatment before incorporation into said portion of the SBR component of the composition.

These aspects and yet further additional aspects of the present invention are detailed hereinafter. For the avoidance of doubt, the combination of features from one or more aspects of the present invention, with one or more additional aspects of the invention to provide a more limited aspect thereof, is specifically included herein as a yet further still aspect of the invention.

### DETAILED DESCRIPTION OF THE INVENTION

The present invention is directed to nanocarbon-reinforced masterbatch compositions of SBR, to methods for the preparation thereof, and to the use of same in reinforced rubber compounds or compositions which include nanocarbon-reinforced SBR with nanocarbon and carbon black as reinforcing agents.

### SBR Master Batches

Styrene-butadiene rubbers (SBR) are copolymers of styrene and butadiene. SBRs having variable properties are possible because of the variability of arrangement of structural units and content of styrene and butadiene in copolymer molecules. For example, low styrene content SBRs (3% to 13% styrene), are more suited for use in rubber products having low-temperature applications, whilst SBRs with higher styrene content (about 15%) have been used in combination with acrylonitrile-butadiene rubbers (NBR) rubbers for production of radial tires. SBRs with higher styrene levels are known as self-reinforcing rubbers (40% to 55% styrene) or fillers (70% to 90% styrene). In general SBRs having a styrene content of from about 23% to 25% have been most widely applied in industry due to their combined elastic and plastic properties.

Any suitable SBR can be used in the compositions and methods herein, including blends of SBRs from different sources/producers, and/or blends of different SBRs i.e. SBRs having different styrene contents. SBR produced by emulsion polymerization (E-SBR) is particularly suitable for use herein. SBRs are typically provided in either latex (E-SBR) or solution (S-SBR) form where the forms denote their production methods, E-SBR being produced by emulsion polymerization initiated by free radicals, and S-SBR being produced by anionic polymerization initiated by alkyl lithium compounds. E-SBR includes L-SBRs which are more pure, emulsified SBRs and which typically do not contain residual emulsifiers.

Advantageously the Applicant has found that where the SBR is employed in latex form processing advantages are provided. SBR latex, also known as emulsion SBR, or E-SBR, is typically provided as a milky white liquid. Essentially the emulsion SBR is a dispersion of SBR microparticles in an aqueous medium. Typically latex E-SBR is commercially available in Mooney viscosities ranging from about 30 to about 120 ML (1+4) at 125° C. Any suitable commercially available SBR latex can be used herein, and particularly latexes having a total solid content of from about from 40% to 50%, and more particularly about 45%. SBR latexes having pH of from about 7.5 to about 9.0, from about 7.5 to about 8.5, of about pH 8.0 are particularly suitable for use herein. SBR latexes having specific gravities of about 1.0 (sg), and boiling points of from about 90° C. to about 110° C., and particularly about 100° C. are particularly suitable for use herein.

SBRs having a styrene content of from about 23% to 25% are preferred, and SBRs having a styrene content of about 23.5% are particularly preferred for use herein.

As discussed hereinbefore, until recently it had not been possible to fully explore and exploit the potential of nanocarbon as a rubber reinforcing agent due to dispersion associated difficulties in processing. The Applicant has developed a novel process for the provision of master batches comprising nanocarbon pre-dispersed in SBR. The improved rubber compositions or rubber compounds for use according to one aspect of the present invention utilize such nanocarbon-reinforced SBR compositions or master batches as their nanocarbon-containing SBR component.

Thus according to a yet further aspect there is provided rubber compositions or rubber compounds made from master batches comprising nanocarbon pre-dispersed in SBR in accordance with the methods herein which are suitable for commercial utility including: use in the manufacture of one or more articles independently selected from: car or light truck tires; truck tire tread compounds; automotive floor mats; brake and clutch pads; footwear such as soles and heels for footwear; domestic and commercial products including floor mats, conveyor belts, garden and industrial hosing, insulation and jacketing for electrical cables; use in foodstuffs including food packaging.

As detailed in the Experimental Results herein, pre-cured rubber compositions, and vulcanized rubber compounds which include nanocarbon-reinforced SBR, from the compositions/master batches as developed by the Applicant, have been shown to provide desirable properties including one or more of: Mooney viscosity; cure on-set/scorch time (t2); and optimum cure time (t95); tensile strength; modulus/elasticity; elongation at break; rolling resilience.

Thus according to an aspect the present invention provides a reinforced SBR composition, also known as a reinforced SBR masterbatch, comprising less than 5 pphr of nanocarbon (relative amount in parts by weight per hundred parts by weight of SBR), wherein the nanocarbon has not been subjected to an acid treatment before incorporation into the SBR masterbatch composition, and wherein the nanocarbon containing SBR component is manufactured from SBR latex and an aqueous dispersion of the nanocarbon.

More particularly, and according to a further aspect the present invention provides a nanocarbon-reinforced SBR masterbatch composition (an SBR masterbatch) comprising less than 5 pphr (parts by weight per hundred parts by weight of SBR) of nanocarbon, wherein the nanocarbon has not been subjected to an acid treatment before incorporation into the SBR, wherein the composition is a liquid composition obtained by combining an aqueous dispersion of the nanocarbon and the SBR, wherein the SBR is in the form of a latex having an solid content of from 40% to 50%, and wherein the composition is masticated either before or after the addition of the aqueous nanocarbon dispersion to the SBR latex.

According to a further aspect the present invention provides a method of making a nanocarbon-reinforced SBR masterbatch wherein the method comprises the following steps:
(i) providing a dispersion of nanocarbon in a aqueous medium, wherein the aqueous medium optionally comprises one or more surfactants;
(ii) providing a styrene butadiene rubber latex, (SBR latex);
(iii) combining the aqueous dispersion of nanocarbon with the SBR latex to provide a liquid composition;
(iv) mixing on a 2-roll mill or in an internal mixer to provide a nanocarbon-reinforced
SBR masterbatch;
(v) addition of one or more masticating agents and mastication in SBR-latex-containing stage (ii) or (iii);
   wherein the nanocarbon is not subjected to an acid treatment before incorporation into the composition, and wherein the nanocarbon-reinforced SBR masterbatch composition comprises less than 5 pphr of nanocarbon, relative amount in parts by weight per hundred parts by weight of SBR.

Mastication is the process by which polymeric rubber is broken-down into lower molecular weight components, this is known as mechanical plasticization, and is sometimes simply referred to as plasticization. Mastication is generally used in the processing of natural rubber, rather than synthetic rubbers such as SBR. The primary reason for mastication of polymer chains to lower their molecular mass, and in natural rubber processing in particular, is to provide master batches having viscosities which are sufficiently low for further processing.

Commercial SBRs for use in any particular process are typically selected on the basis of their suitability for further processing on the basis of their molecular weight and viscosity. As such synthetic rubbers such as SBR are not generally masticated. In addition, inherent difficulties associated with the inefficiency of mastication of synthetic rubbers, such as SBR, leads to the pre-selection of a suitable SBR for the intended process.

Surprisingly the Applicant has found not only that it is possible to efficiently and effectively masticate SBR containing compositions, but also that such mastication is particularly effective where the composition contains nanocarbon, and optionally wherein one or more mastication agents is also employed.

Thus, according to a yet further aspect the present invention provides a method of preparing a nanocarbon-reinforced SBR masterbatch composition as defined hereinbefore wherein the combined nanocarbon dispersion and SBR latex mixture is mechanically masticated (plasticized).

In addition to mechanical mastication, one or more chemical masticating agents, also known as mechanical masticating or mechanical peptizing agents may be incorporated in the mastication step herein, and each agent may be independently present at levels of from 0.1 to about 0.3 pphr by weight relative to the weight of SBR latex. As detailed in the Experimental section herein, the purpose of the chemical masticating agent(s) is to further enhance the mechanical processing (mastication) of the SBR and thereby improve the dispersion of the nanocarbon into the SBR matric. Chemical masticating agents for use herein include one or more chemical masticating agents, are preferably transition metal salts of fatty acids, and includes; one or one or more peptizing agents and mixtures and combinations thereof. Exemplary peptizing agents for use herein are independently selected from: one or more zinc soaps of unsaturated fatty acids, such as for example the mixture of zinc soaps of unsaturated fatty acids available as Struktol A50P; Zn salts of oleic acid available from JinYan Chemical (ShangHai) Co., Ltd, China; Zn salts of linoleic acid available from Tetrahedron Scientific Inc., Hangshou, 310053 China; Zn salts of a-linoleic, or Zn salts of omega-3 fatty acids such as eicosapentaenoic acid (EPA), or Zn salts of docosahexaenoic acid (DHA), or mixtures thereof; Zn-salts of pentachlorothiophenol such as Renacit 7 (or VII) also known as Peptizer 103, available from Sinobase Polymers Chemical Limited, Guangdong, China, or Peptazin Zn available from J. Dimitrov Chemical Works, CZ; and/or di(o-benzamidophenyl)disulphide available as Pepton 22 from the Aurora Chemical Co. Ltd., Quingdao, Shandong, China; and the like; and mixtures thereof. Preferred for use herein are one or more zinc soaps of unsaturated fatty acids.

Where one or more chemical masticating agents is present it is preferred that such agents are added to the SBR component prior to mixing (mastication), i.e. addition with the aqueous dispersion of nanocarbon, addition to the SBR component before combination with the aqueous dispersion.

Thus, according to a yet further aspect the present invention provides a method of preparing a reinforced SBR masterbatch as defined hereinbefore wherein the combined nanocarbon dispersion and SBR latex mixture is mechanically masticated with one or more chemical masticating (peptizing) agents, wherein each masticating agent is present at a level of from 0.1 to 0.3 pphr by weight relative to the weight of SBR latex and wherein said masticating agent is optionally one or more zinc soaps of unsaturated fatty acids.

According to a further aspect there is provided a method of preparing a reinforced SBR masterbatch in accordance with any of the aspects herein wherein one or more chemical masticating agents is present and wherein the chemical masticating agent(s) is/are zinc salts. According to a yet further aspect the present invention provides a method of preparing a reinforced SBR masterbatch as defined hereinbefore, wherein the combined nanocarbon dispersion and SBR latex mixture is mechanically masticated with one or more chemical masticating (peptizing) agent, wherein the combined level of masticating agents is from 0.1 to 0.3 pphr by weight relative to the weight of SBR latex, wherein said one or more masticating agents is/are optionally one or more zinc soaps of unsaturated fatty acids and wherein the SBR is present as a latex having a total solid content of about 45%, a pH of about 8.0, specific gravity of about 1.0 and a boiling point of about 100° C.

The Applicant has found that the nanocarbon-reinforced SBR masterbatch compositions and method for their preparation according to aspects of the present invention as detailed herein overcome the problems of poor dispersion of nanocarbon which are traditionally associated with direct mixing of nanocarbon with dry rubber. Furthermore, the Applicant has found that use of such nanocarbon-reinforced SBR in rubber compositions and/or rubber compounds yields uncured compositions and vulcanized (cured) compounds having improved physical properties and mechanical strength, improved modulus, tensile strength, and desirable hardness, rolling resistance and elongation at break.

Further processing agents which can be incorporated into SBR latex during mixing with the nanocarbon dispersion, or alternatively by mixing directly into the nanocarbon-SBR masterbatch on a 2-roll mill or in an internal mixer and which maintain or further improve the dispersion of nanocarbon into the SBR latex, include: one or more ester, phosphate, or ether chemical plasticizers such as dioctyl phathalate (DOP), dioctyl sebacate (DOS), dibutyl sebate, trixytyl phosphate and mixtures and combinations thereof; one or more nonionic dispersing agents such as soaps of saturated fatty acid esters, including one or more calcium soaps of fatty acids, such as for example Struktol WB16 or aliphatic fatty acid esters such as Struktol WB222 available from the Struktol Company of America, Ohio 44224-0649, USA or mixtures thereof wherein said nonionic dispersing agent is a nonionic surfactant/wetting agent having a hydrophilic-lipophilic balance (HLB) value of from 4 to 8; one or more homogenizing agents such as aromatic resins for example Struktol 40MS; and mixtures or combinations thereof. These agents may be incorporated into SBR latex during mixing with the nanocarbon, or alternatively by mixing directly into the nanocarbon-reinforced-SBR masterbatch on a 2-roll mill or in an internal mixer. Chemical plasticizers having solubility parameters similar to those of the particular SBR latex in any given masterbatch composition may further enhance nanocarbon dispersion into the SBR matrix.

Thus, according to a further aspect the present invention provides a method of preparing a reinforced SBR masterbatch as defined hereinbefore wherein the combined nanocarbon dispersion and SBR latex mixture including one or more chemical masticating agents, and optionally one or more surfactants and/or one of more stabilizing agents, is mechanically masticated with one or more processing agents independently selected from: chemical plasticizers as detailed hereinbefore, and in particular dioctyl phathalate (DOP), and dioctyl sebacate (DOS) and mixtures or combinations thereof; one or more dispersing agents as defined hereinbefore, and in particular saturated fatty acid soaps for example Struktol WB16, or aliphatic fatty acid esters, for example Struktol WB222, or mixtures or combinations thereof; one or more homogenizing agents as defined hereinbefore, and in particular aromatic resins for example Struktol 40MS; one or more mechanical peptizers such as mixtures of high molecular weight aliphatic and aromatic esters, such as for example Struktol WB300; and mixtures or combinations thereof, wherein each of said processing agents may be independently present at a level of from 0.1 to 0.45 pphr weight relative to the weight of SBR latex and wherein the total level of such processing agents is from 0.1 to 2.0 pphr, from 0.1 to 1.0 pphr, from 0.1 to 0.9 pphr by weight relative to the weight of SBR latex.

### Nanocarbon I Nanocarbon Dispersions

Nanocarbon (NC) as defined herein relates to nano-sized carbon materials, also known as nano-sized carbon structures, or nanocarbons and includes the carbon allotrope graphene, as well as structures based on graphene such carbon nanotubes (CNTs) which are also carbon allotropes and are sometimes referred to as buckytubes, and/or carbon nanofibers (CNFs).

Exemplary nano-sized forms of carbon suitable for use herein include: graphene; all types of single-, double-, or multi-walled carbon nanotubes (CNTs) and mixtures thereof; carbon nanotubes (CNTs); all types of carbon nanofibers (CNFs), including vapor grown carbon nanofibers (VGCNFs) and mixtures thereof; all types of graphite nanofibers (GNFs), including platelet graphite nanofibers (PGNFs) and mixtures thereof; and mixtures of different nano-sized carbon structures. CNTs or GNFs suitable for use herein include for example helical, linear or branched type. VGCNFs suitable for use herein are cylindrical nanostructures with graphene layers arranged as stacked cones, cups or plates.

Any nanocarbon (NC) as defined herein may be used for the preparation of an SBR-nanocarbon masterbatch according to the method outlined herein. CNTs, VGCNFs and/or PGNFs are preferred. Particulate forms of nanocarbon, especially particulate forms of CNTs, VGCNFs and/or PGNFs are suitable for use herein.

Any commercially available form of nanocarbon, including commercially available CNTs, VGCNFs, PGNFs, and/or graphene may be utilized in the methods herein. Suitable commercially available forms of nanocarbon for use herein include: Graphistrength® C100 CNT's available from Arkema Inc. King of Prussia, Pa. 19406 USA; carbon nanotubes from Nanocyl, 5060 Auvelais, BE such as NC7000™, SWCNTs and DWCNTs; carbon nanomaterials such as single-walled carbon nanotubes (SWCNTs), double-walled carbon nanotubes (DWCNTs), multi-walled carbon nanotubes (MWCNTs), carbon nanofibers or carbon nanochips from Sigma Aldrich, Dorset SP8 4XT, UK; CNT dispersions from Ugent, B-9052 Gent, BE; graphene materials from Graphene NanoChem PLC, Tech Sdn Bhd, Senawang, Malaysia; Graphistrength® C100 CNT's are derived from bio-alcohol, i.e. a renewable source, and are of particular utility herein.

CNTs particularly suitable for use herein are typically supplied in the form of agglomerated bundles with average dimensions of from 0.05 mm to 1.5 mm.

The concentration of nanocarbon and in particular the concentration of CNT, VGCNF or PGNF, pre-dispersed in the reinforced SBR-nanocarbon masterbatch is less than 5 g of nanocarbon per 100 g of SBR. In other words the masterbatch contains less than 5 parts by weight (pphr) nanocarbon per 100 parts by weight of SBR i.e. <5 pphr CNT.

CNTs having a length of less than about 50 μm (<50 μm) and/or an outer diameter of less than about 20 nm (<20 nm) are preferred. Especially preferred are CNTs having a length of <50 μm and/or an outer diameter 20 nm, and having a C-purity of greater than 85% and non-detectable levels of free amorphous carbon.

Master batches suitable for use herein may, for example, include from about 0.5 to about 4.5 pphr nanocarbon per 100 parts by weight of SBR. For the avoidance of doubt all references to nanocarbon-reinforced SBR masterbatch compositions, nanocarbon-reinforced SBR compositions, and nanocarbon-reinforced rubber compositions or compounds which include nanocarbon-reinforced SBR are equally applicable to CNT-reinforced SBR masterbatch compositions, CNT-reinforced SBR compositions, and CNT-reinforced rubber compositions or compounds which include CNT-reinforced SBR.

Preferred master batches for use may herein include: from about 0.5 to about 4 pphr CNT, preferably from about 1 to about 3 pphr CNT, more preferably from about 2 to about 3 pphr CNT per 100 parts by weight of SBR; from about 0.5 to about 4 pphr PGNF, preferably from about 1 to about 3 pphr PGNF, more preferably from about 2 to about 3 pphr PGNF per 100 parts by weight of SBR; and mixtures thereof. Particularly preferred master batches include about 3 pphr CNT. Carbon nanotubes, CNTs are preferred.

Thus according to an aspect the present invention provides reinforced SBR composition, also known as a reinforced SBR masterbatch, comprising less than 5 pphr of nanocarbon (relative amount in parts by weight per hundred parts by weight of SBR), wherein the nanocarbon has not been subjected to an acid treatment before incorporation into the rubber composition, wherein the nanocarbon containing SBR component is manufactured from SBR latex and a liquid dispersion of the nanocarbon, and wherein the nanocarbon is in the form of CNTs.

Importantly, the methods according to the present invention effectively and uniformly disperse nanocarbon, and preferably CNTs within an SBR rubber matrix. Utility of SBR in latex (liquid) form in the present methods has been demonstrated to overcome the disadvantages commonly associated with incorporation of particular materials into rubber matrices.

Contrary to previous reports, and as demonstrated in the Experimental Results hereinafter, the Applicant has found that nanocarbon which has not been subjected to acid pre-treatment provides improved physical properties when compared to acid pre-treated nanocarbon. In particular, the present methods provide an improvement over the teaching of the prior methods of CN 1663991 A and CN 1673261 A as it has been demonstrated that better physical and mechanical properties, such as improved hardness, improved modulus and/or improved tensile strength are provided without the acid pre-treatment step for the nanocarbon.

In the preparation of nanocarbon-reinforced SBR masterbatch compositions herein the nanocarbon is utilized as a nanocarbon dispersion. A nanocarbon dispersion as defined herein is a dispersion of nanocarbon in a suitable aqueous medium, in other words, an aqueous nanocarbon dispersion. The nanocarbon dispersion is combined with the SBR latex to form the nanocarbon-reinforced SBR masterbatch in accordance with the method(s) detailed herein.

The concentration of the nanocarbon in the nanocarbon dispersion used in the present invention is generally 1% to 5% by weight (expressed as weight of nanocarbon relative to total weight of the aqueous dispersion).

Nanocarbon dispersions for use in the methods and compositions herein may be prepared by forming a slurry of nanocarbon in an aqueous medium, and wherein the aqueous medium preferably contains one or more surfactants and optionally one or more stabilizing agents. Prior to further utility within the present method the so-formed slurry is then preferably subjected to grinding, for example by ball milling or alternatively by using an attrition mill, to break down any agglomeration or aggregation of the nanocarbon. Such grinding process provides an aqueous nanocarbon dispersion wherein the nanocarbon is uniformly dispersed. The grinding process is typically carried out for 6 to 48 hours, preferably for 12 to 24 hours.

Prior to combination of the nanocarbon dispersion with the SBR latex, the pH of the nanocarbon dispersion and/or of the SBR latex is/are adjusted so that the pH values of the two components (dispersion and latex) are similar or identical. In particular, the pH of the so-adjusted SBR latex is between: pH 8.0 and pH 10.0; pH 8.0 and pH 9.0; between pH 8.0 and pH 8.5. Preferably, the difference between the pH value of the nanocarbon dispersion and the pH value of the SBR latex is less than 2 pH units, more preferably less than 1 pH unit, most preferably less than 0.5 pH units before the dispersion and the latex are combined. Independent adjustment of the pH of the latex and/or the dispersion can be carried out using any suitable acid or base as required, the selection of suitable acids or bases is considered to be within the skill of the relevant person. Exemplary bases and acids suitable for use herein are aqueous (dilute) solutions of potassium hydroxide and hydrochloric acid.

The nanocarbon dispersion and the SBR latex may be combined by adding the nanocarbon dispersion, preferably a nanocarbon dispersion containing one or more surfactants, and optionally one or more stabilizing agents to the SBR latex, for example by discharging the former into a vessel containing the latter. The mixture thus obtained is generally subjected to mechanical stirring and mastication (plasticization) until a uniform mixture is obtained.

Alternatively nanocarbon dispersion and a separate aqueous surfactant solution may be added substantially simultaneously, or one after the other, to the SBR latex i.e. the added aqueous component comprises an aqueous nanocarbon dispersion and an aqueous surfactant solution.

Suitable chemical masticating agents for use herein are as indicated hereinbefore.

Thus according to a further aspect the present invention provides a nanocarbon-reinforced styrene-butadiene rubber masterbatch composition (an SBR masterbatch) comprising less than 5 pphr (parts by weight per hundred parts by weight of SBR) of nanocarbon, wherein the nanocarbon has not been subjected to an acid treatment before incorporation into the SBR, wherein the composition is a liquid composition obtained by combining a liquid dispersion of the nanocarbon and the SBR, wherein the SBR is in the form of a latex having an solid content of from 40% to 50%, wherein the composition is masticated either before or after the addition of the nanocarbon dispersion to the SBR latex, wherein the pH of the nanocarbon dispersion and/or of the SBR latex is/are adjusted prior to such combination so that the difference between the pH value of the nanocarbon dispersion and the pH value of the SBR latex is less than 2 pH units, and wherein the pH of the so-adjusted SBR latex is between pH 8.0 and pH 10.0.

According to a further aspect the present invention provides a method of making a nanocarbon-reinforced SBR masterbatch wherein the method comprises the following steps:
(i) providing a styrene butadiene rubber latex, (SBR latex);
(ii) providing a dispersion of nanocarbon in aqueous medium wherein the aqueous medium optionally comprises one or more surfactants at a level of from 5% to 20% by weight of the aqueous medium;
(iii) measuring the pH of the nanocarbon dispersion and the SBR latex and adjusting so that the difference between the pH value of the nanocarbon dispersion and the pH value of the SBR latex is less than 2 pH units and the pH of the SBR latex is between pH 8.0 and pH10.0;
(iv) combining the dispersion of nanocarbon to the SBR latex;
(v) mixing on a 2-roll mill or in an internal mixer to provide a nanocarbon-reinforced-SBR masterbatch;
(vi) addition of one or more optional masticating agents and mastication in SBR-latex-containing stage (i) or (iv); and
   wherein the nanocarbon is not subjected to an acid treatment before incorporation into the composition, and wherein the nanocarbon-reinforced-SBR masterbatch composition comprises less than 5 pphr of nanocarbon, relative amount in parts by weight per hundred parts by weight of SBR.

Any suitable surfactant may be utilized to enhance the dispersion of the nanocarbon within the aqueous medium. Where the surfactant is present in the nanocarbon dispersion the total level of surfactant present in the aqueous medium (aqueous solution) is from 5% to 20% by weight of the solution, expressed as weight of surfactant relative to total weight of the aqueous dispersion.

Where the surfactant is provided via a separate aqueous solution from the nanocarbon dispersion, then the total level of surfactant present in the aqueous medium (aqueous solution) is from 5% to 20% by weight of the solution, expressed as weight of surfactant relative to total combined weight of the added aqueous component, the combined weights of the aqueous dispersion and the aqueous surfactant solution.

Exemplary surfactants are nonionic emulsifying agents, including one or more alkali or alkali earth metal salts of C₈-C₁₈ fatty acids, such as for example Na or K salts of lauric acid, or Mg or Ca salts of alternative fatty acids. Further exemplary surfactants suitable for use herein include one or more alkali or alkali earth metal salts of caprylic (C-8), capric (C-10), lauric (C-12) myristic (C-14), palmitic (C-16), stearic (C-18), oleic (C-18), linoleic (C-18) or linoleic (C-18) acids and mixtures thereof, and more particularly one or more alkali or alkali earth metal salts of C₁₂-C₁₈ fatty acids. Suitable commercially available nonionic surfactants for use herein include: sodium laurate/sodium dodecanoate (sc-215871) from Santa Cruz Biotechnology Inc. California 95060, USA; potassium laurate/potassium dodecanoate (Ser. No. 05/217,551) from MP Biomedicals, Santa Ana, Calif., USA; calcium laurate/calcium dodecanoate (0521771) from MP Biomedicals, Santa Ana, Calif., USA.

Thus according to a further aspect there is provided a method according to any of the aspects detailed herein wherein the added aqueous component includes: one or more nonionic surfactants; one or more alkali or alkali earth metal salts of C8-C18 fatty acids; one or more alkali or alkali earth metal salts of C1rC18 fatty acids; Na or K salts of lauric acid.

The mixture containing the SBR latex, the nanocarbon and one or more optional agents independently selected from: one or more surfactants; one or more stabilizing agents; and mixtures thereof may then be coagulated. For the avoidance of doubt, any suitable known coagulants may be used. Exemplary coagulants for use herein include aqueous solutions of: calcium chloride; calcium nitrate; sulphuric acid; and mixtures or combinations thereof, and more particularly aqueous solutions of: calcium chloride at 20% aqueous concentration; calcium nitrate at from 15% to 25% aqueous concentration; dilute sulphuric acid at from 40% to 70% aqueous concentration; and mixtures thereof or combinations thereof.

The coagulum thus formed may be washed with water and squeezed to remove excess surfactants and water. The coagulum may be cut into small granules and washed with water. These granules may then be dried, for example in an electrically heated oven, until they are fully dried. The resulting dried rubber product may be used directly in this granulated form, or it may be further pressed into a bale to provide block rubber. The dry rubber product, in granulated or block “rubber” form may be used as a nanocarbon-reinforced SBR master batch or a CNT-reinforced SBR masterbatch where CNT is used, in the preparation of rubber compositions and vulcanized rubber compounds for use in a wide variety of SBR rubber applications including those in which currently available dry SBR grades are employed.

Thus, according to a yet further aspect there is provided a nanocarbon-reinforced SBR dry rubber product, in granulated or block “rubber” form may be used as a nanocarbon-reinforced SBR master batch, or a CNT-reinforced SBR masterbatch where CNT is used, in the preparation of rubber compositions and vulcanized rubber compounds for use in a wide variety of SBR rubber applications including: use in the manufacture of one or more articles independently selected from: car or light truck tires; truck tire tread compounds; automotive floor mats; brake and clutch pads; footwear such as soles and heels for footwear; domestic and commercial products including floor mats, conveyor belts, garden and industrial hosing, insulation and jacketing for electrical cables; use in foodstuffs including food packaging.

As detailed hereinbefore the nanocarbon-reinforced SBR masterbatch compositions of the present invention comprise: less than 5 pphr by weight of nanocarbon per 100 parts by weight of SBR; from about 0.5 to about 4.5 pphr nanocarbon per 100 parts by weight of SBR; from 30 about 0.5 to about 4 pphr nanocarbon; from about 1 to about 3 pphr nanocarbon; from about 2 to about 3 pphr nanocarbon per 100 parts by weight of SBR. For the avoidance of doubt, “pphr” as used herein in relation to the composition of components in the SBR masterbatch compositions stands for parts (by weight) per hundred parts (by weight) of SBR; thus, the composition contains less than 5 g of nanocarbon per 100 g of SBR). The Applicant has found that compositions comprising 5 pphr of nanocarbon or more were found to result in worse mechanical properties.

The Applicant has also found that where the nanocarbon is CNT, the resultant CNT-reinforced SBR masterbatch compositions typically have Mooney viscosities in the range of from 90 to 120 Mooney units, M_{L} (1+4) 100° C. For certain uses, such as for example utility in automotive or heavy duty tyre applications lower viscosities are desirable for further processing efficiencies. The Applicant has found that the Mooney viscosities of CNT-reinforced SBR master batches is reduced by incorporation of one or more of chemical plasticizers, dispersing agents, homogenizing agents, and/or mechanical peptizers, or mixtures thereof. Exemplary chemical- and mechanical-plasticizers, dispersing agents and homogenizing agents are detailed hereinbefore. As previously discussed these chemicals may be incorporated into SBR latex during mixing with the CNT dispersion, or alternatively by mixing directly into the CNT-SBR masterbatch on a 2-roll mill or in an internal mixer.

Thus, the composition and method of the present invention overcome the problem of poor dispersion of nanocarbon when direct mixing of nanocarbon with dry rubber and yield improved physical properties, and in particular desirable Mooney viscosities, and mechanical strength of the rubber composition.

According to a further aspect the present invention provides reinforced rubber compositions and vulcanized rubber products which nanocarbon reinforcing agent from dry nanocarbon-reinforced SBR product. As detailed herein the Applicant has found that such reinforced rubber compounds have desirable viscosity and cure characteristics (pre-vulcanisation) and desirable strength and other mechanical properties (post-vulcanisation).

In particular, the Applicant has found that tensile strength may be used to assess the quality of the vulcanized rubber compositions containing nanocarbon reinforced SBR prepared in accordance with the methods detailed herein. This is because tensile strength is especially sensitive to flaws that arise from poor filler dispersion, imperfect molding and/or impurities within the composition. Agglomerates of filler act as a flaw and provide sites for high stress concentration where failure occurs. It is known that there is a strong correlation between poor dispersion of filler and low tensile strength.

As demonstrated in the Experimental Methods Section herein, the Applicant has shown that the nanocarbon reinforced SBR masterbatch compositions and rubber compositions prepared from the nanocarbon reinforced SBR masterbatch compositions have improved tensile strength versus control SBR master batches and SBR containing compositions.

### Rubber Compositions Containing Nanocarbon Reinforced SBR

The Applicant has found that rubber compositions which include nanocarbon reinforced SBR (prepared from master batches) as detailed hereinbefore have desirable cure characteristics and mechanical properties.

As detailed in the Experimental Results herein, rubber compositions which include nanocarbon reinforced SBR, from master batches as developed by the Applicant, and as detailed hereinafter, provide desirable physical properties including one or more of: Mooney viscosity; cure on-set/scorch time (t2); and optimum cure time (t95); and post-vulcanization their vulcanizates deliver desirable tensile strength; modulus/elasticity; elongation at break; rolling resilience.

According to a further aspect the present invention provides a reinforced styrene-butadiene rubber (SBR) composition wherein said composition comprises a mixture of rubber, nanocarbon and carbon black, wherein the relative amount of nanocarbon to carbon black, expressed in parts by weight per hundred parts by weight (pphr) of rubber, is in the range of about 1:100 to about 1:9, wherein the relative amount of nanocarbon to rubber is in the range of about 0.5:100 to about 4.5:100, expressed in parts by weight per hundred parts by weight (pphr) of rubber, wherein the nanocarbon component is pre-dispersed within at least a portion of the SBR component and wherein the nanocarbon has not been subjected to an acid treatment before incorporation into said portion of the SBR component of the composition.

For the avoidance of doubt the nanocarbon contained in the reinforced SBR component of such composition is as defined hereinbefore. The term rubber composition refers to the composition of a formulation prior to vulcanization and the term rubber compound refers to a cured vulcanizate.

In such nanocarbon-reinforced SBR rubber compositions or rubber compounds, the rubber content includes a nanocarbon-reinforced SBR rubber component, as defined hereinbefore, and optionally one or more further rubber components. Such optional additional rubber components include natural rubber and virgin (non-reinforced) SBR and mixtures thereof. For the avoidance of doubt these optional additional rubber components may be present as blends i.e. blends of natural rubbers and/or virgin SBRs from different sources/producers, and/or blends of different virgin SBRs i.e. SBRs having different styrene contents.

In addition to the nanocarbon-reinforced SBR component the rubber compositions herein additionally comprise further rubber-based and non-rubber components. Such further rubber-based component may be a natural or a synthetic rubber, and is preferably non-nanocarbon reinforced SBR.

Thus according to a further aspect the present invention provides reinforced compositions containing SBR wherein the SBR comprises a nanocarbon-reinforced component as defined hereinbefore and a non-reinforced SBR component.

According to a further aspect the present invention provides a reinforced styrene-butadiene rubber (SBR) composition wherein said composition comprises a mixture of rubber components, nanocarbon and carbon black, wherein the relative amount in parts by weight per hundred parts by weight of nanocarbon-reinforced SBR (NC-SBR-pphr) to non-reinforced (virgin) SBR is in the range of from 4:5 to about 5:4 and wherein the wherein the relative amounts in parts by weight per hundred parts by weight of nanocarbon to carbon black is in the range of: about 1:100 to about 1:9; 1:50 to about 1:7; about 1:50 to about 1:15; about 1:40 to about 1:20; about 1:33, wherein the relative amount of nanocarbon to total rubber is in the range of: about 0.5:100 to about 4.5:100; about 1:100 to bout 1:25; about 1:100 to about 1:33; about 1:66 to about 1:33; about 1:33, wherein the nanocarbon component is pre-dispersed within the nanocarbon-reinforced SBR component, and wherein the nanocarbon has not been subjected to an acid treatment before incorporation into reinforced SBR component of the composition.

Further agents which may be incorporated into the pre-vulcanized rubber compositions include any one or more of the following: one or more curing agents; one or more activators; one or more delayed-accelerators; one or more antioxidants; one or more processing oils; one or more waxes; one or more scorch inhibiting agents; one or more processing aids; one or more tackifying resins; one or more reinforcing resins; one or more peptizers, and mixtures thereof.

Thus according to a yet further aspect the present invention provides nanocarbon-reinforced rubber compositions comprising nanocarbon-reinforced SBR, one or more additional rubber components, one or more additional reinforcing agents and one or more vulcanizing or curing agents, and any of one or more of: one or more activators; one or more delayed-accelerators; one or more antioxidants; one or more processing oils; one or more waxes; one or more scorch inhibiting agents; one or more processing aids; one or more tackifying resins; one or more reinforcing resins; one or more peptizers, and mixtures thereof.

According to a further aspect the present invention provides nanocarbon-reinforced rubber compositions comprising nanocarbon-reinforced SBR, one or more additional rubber components, one or more additional reinforcing agents including carbon black, one or more vulcanizing or curing agents, one or more vulcanizing activating agents; one or more vulcanizing delayed-accelerators; one or more antioxidants; one or more processing oils and mixtures thereof.

### Carbon Black

Any carbon black suitable for reinforcing rubber may be used in the rubber compositions for use according to the invention. Examples of suitable carbon black include: super abrasion furnace (SAF N110); intermediate super abrasion furnace (ISAF) N220; high abrasion furnace (HAF N330); easy processing channel (EPC N300); fast extruding furnace (FEF N550); high modulus furnace (HMF N683); semi-reinforcing furnace (SRF N770); fine thermal (FT N880); and medium thermal (MT N990).

Any commercially available carbon blacks suitable for reinforcing rubber may be utilized herein. Suitable commercially available carbon blacks for use herein include: SAF N110, ISAF N220, EPC N300, FEF N550, and FT N880 all available from Yucheng Jinhe Industrial Co., Ltd, China; HAF N330 available from Henan Premtec Enterprise Corporation, China; HMF N683 available from the Continental Carbon Company, Houston, Tex., USA; SRF N770 and MT N990 available from Zouping Changshan Zefeng Fertilizer Co., Ltd, China.

Carbon black may be included at a level of from about 10 pphr to 50 pphr; 20 pphr to 40 pphr, preferably from 25 pphr to 35 pphr and preferably from 30 pphr to 35 pphr in rubber compositions according to the invention wherein pphr is the weight versus 100 parts of the total rubber present in the composition i.e. reinforced SBR, and virgin SBR and/or natural rubber.

ISAF N220 is a preferred form of carbon black for use in compositions according to the invention. The Applicant has found that rubber compositions for use according to the invention, and as demonstrated in the Examples hereinafter, are capable of delivering both improvements in key processing attributes, as well as improvements in highly desirable performance attributes, such as tensile strength, elongation at break in comparison to a non-nanocarbon reinforced SBR-containing formulation having far higher carbon black components. In particular, the reinforced compositions of the invention which include carbon black at from about 10% to less than about 40% less than in the control formulation have been shown to provide desirable hardness, whilst improving tensile strength and resilience.

The Applicant has also found that particular combinations of nanocarbon and carbon black reinforcing agents are valuable for the delivery of desirable properties in the nanocarbon-reinforced SBR compositions according to the invention. Such combinations are illustrated in the Examples hereinafter.

For the avoidance of doubt where amounts of any materials or components are referred to herein in relation to pphr of a vulcanized rubber product, a “rubber composition”, the pphr means parts per hundred of the pre-vulcanized rubber composition.

### Additional Rubber Composition Component(s)

Any natural sourced or synthetic rubber may be utilized as an additional rubber component in the rubber compositions herein.

Natural sourced rubbers which may be used in the compositions according to the invention include one or more: unprocessed and processed latex products such as ammonia containing latex concentrates; RSS, ADS or crepes; TSR, SMR L, SMR CV; or specialty rubbers SP, MG, DP NR; or field grade (cup lump) rubber products such as TSR, SMR 10, SMR 20, SMR 10 CV, SMR 20 SV, SMR GP and SMR CV60. Further examples of natural rubbers suitable for use herein include chemically modified natural rubber products including: epoxidized natural rubbers (ENRs) such as for example ENR 25 and ENR 50. For the avoidance of doubt, all references to additional natural sourced rubber component in relation to the compositions according to the invention are to natural rubber as defined herein.

Synthetic rubbers which may be used as additional rubber components in the compositions herein include one or more: E-SBRs as defined hereinbefore; ABRs as defined hereinbefore; LSBRs as defined hereinbefore; and mixtures and combinations thereof.

Examples of suitable vulcanization agents for inclusion to the rubber compositions of the invention include sulphur or other equivalent “curatives”. Vulcanizing agents, also referred to as curing agents, or sometimes referred to as cross linkers, modify the polymeric material (polyisoprene) in the natural rubber containing component to convert it into a more durable material for commercial utility, and may be included at a level of from about 1 pphr to about 4 pphr, preferably from about 1 pphr to about 3 pphr and preferably from about 1.5 pphr to about 2.5 pphr in formulations according to the invention. Sulphur is the preferred vulcanizing agent for incorporation into the compositions according to the invention.

Examples of suitable vulcanizing activating agents for inclusion to the rubber compositions of the invention include zinc oxide (ZnO), stearic acid (octadecanoic acid), stearic acid/palmitic acid mixture, or other suitable alternatives. It is thought that vulcanizing activating agents essentially accelerate the rate of vulcanization. Activators and co-activators are essential materials to enhance activation (initiation) of the vulcanization process. Vulcanizing activating agents can be included at a total level of from about 2 pphr to about 10 pphr, preferably from about 3 pphr to about 7 pphr and preferably from about 4 pphr to about 6 pphr. Zinc oxide and stearic acid are preferred vulcanizing activating agents for incorporation into the compositions according to the invention at individual levels of zinc oxide at a level of from about 1.5 pphr to about 8 pphr, preferably from about 2 pphr to about 6 pphr and preferably about 5 pphr and stearic acid at from about 0.5 pphr to about 4 pphr, preferably from about 1 pphr to about 3 pphr.

Examples of suitable vulcanizing delayed-accelerators for inclusion in the rubber compositions of the invention include any one of or combination of the following: N-cyclhexyl-2-benzolthiazole sulfenamide (CBS); N-tertiary-butyl-benzothiazole-sulphenamide (TBBS) available from Sigma Aldrich (95-31-8); 2-Mercaptobenzothiazole (MBT); 2.2′-Dibenzothiazole Disulfide (MBTS); 2-(2,4-Dinitrophenylthio) benzothiazole (DNBT); Diphenylguanidine (DPG); Diethyldiphenylthiuram disulphide; Tetramethylthiuram disulphide; Tetramethyl Thiuram Monosulfide (TMTM); N,Ndicyclohexyl-2-benzothiazole sulfenamide (DCBS); N-oxydiethylene thiocarbamyl-N′-oxydiethylene sulphenamide (OTOS) and the like. It is thought that vulcanizing delayed accelerators essentially assist the vulcanization process by increasing the vulcanization rate at higher temperatures. Vulcanizing delayed-accelerators can be included at a level of from about 0.5 pphr to about 3 pphr, preferably about 1 pphr to about 2 pphr.

Antioxidants, which provide protection against oxidation and heat aging, and antiozonants, which provide protection against ozone cracking and flex cracking, can be generally considered to be chemicals which are included into the composition to impart protection against, or improved resistance to surface attack, or surface degradation. Examples of suitable antiozonants for inclusion to the rubber compositions of the invention include any one of or combination of the following: N-(1,3-dimethylbutyl)-N′-phenyl-p-phenylenediamine (6PPD) available as Santoflex 13 from the Eastman Chemical Company, USA; 2-mercaptobenzimidazole compounds; 2-benzimidazolethiol; Dialkylated diphenylamines; octylated diphenylamine; Nickel dibutyldithiocarbamate; N-isopropyl-N′-phenyl-p-phenylene diamine; 4′-diphenyl-isopropyl-dianiline; 2,2′-Methylenebis(6-tert-butyl-4-methylphenol); paraffin waxes such as Antiflux 654.

Individual antioxidants and antiozonants can be included at a level of from about 0.5 pphr to about 5 pphr, preferably from about 2 pphr to about 4 pphr. A combination of antioxidants can be included at a combined level of from 1 pphr to about 10 pphr, preferably from about 2 pphr to about 6 pphr.

Examples of suitable processing oils for inclusion in the rubber compositions of the invention include mineral oils, including aromatic oils, napthalenic oils, paraffinic oils and mixtures thereof, such as for example heavy napthaleinic oils, Nytex 840, and/or napthanlenic oils such as Shellflex 250 MB/Catenex Oil 5523. Processing oils can be included at a level of from about 2 pphr to about 6 pphr, preferably from about 3 pphr to about 5 pphr, and especially from about 4 pphr to about 4.5 pphr.

Examples of suitable optional additional reinforcing agents for inclusion in the rubber compositions of the invention which can be included at levels of from 0.5 pphr to 2 pphr, include one or more silicas, silanes and/or clays, such as for example: silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2, VN3, VN3 GR; silanes commercially available from Evonik such as Si 363® and Si 69® (Bis[3-(triethoxysilyl)propyl]tetrasulfide). Where an optional, additional silica based reinforcing agent is used then a suitable coupling agent, such as a silane may also be included.

Additional agents which can be included into the rubber compositions, post mastication include further peptizers such as for example AP-zinc Pentachlorobenzenethiol zinc, WP-1, HP, at levels of from 1 to 2 pphr.

### BRIEF DESCRIPTION OF THE DRAWINGS

FIG. 1: illustrates a sample micrograph of the 3 pphr CNT reinforced SBR matrix of Example 1, captured using Field Emission Scanning Electron Microscope (FESEM) model LEO 1525, and shown at 100× magnification. SEM micrograph of a sample from a SBR masterbatch reinforced with 3 pphr of CNT at 100× magnification.

FIG. 2: illustrates a sample micrograph of the 3 pphr CNT reinforced SBR matrix of Example 1, captured using FESEM model LEO 1525, shown at 200× magnification, and with the diameter of the CNT measured.

FIG. 3: is a histogram showing the relative effects of mechanical peptizer on Mooney viscosity, Vc of four unvulcanised compositions: Mix 1—gum SBR, Mix 2—SBR+3 pphr carbon black (ISAF), Mix 3—SBR+3 pphr CNT, Mix 4—SBR+3 pphr CNT (MB pre-masticated with mechanical peptizer).

FIG. 4: is a histogram showing the effect of mechanical peptizer on hardness of four vulcanised compositions: Mix 1—gum SBR, Mix 2—SBR+3 pphr carbon black (ISAF), Mix 3-SBR+3 pphr CNT, Mix 4—SBR+3 pphr CNT (MB pre-masticated with mechanical peptizer).

FIG. 5: is a histogram showing the effect of mechanical peptizer on M100 and M300 of the four vulcanised compositions as indicated in FIG. 4.

FIG. 6: is a histogram showing the effect of mechanical peptizer on tensile strength of the four vulcanised compositions as indicated in FIG. 4.

FIG. 7: is a histogram showing the effect of CNT on Mooney viscosity of SBR-carbon black-filled rubber compound in four test vulcanised rubber compounds (black-filled SBR vulcanizates) and a reference compound: Mixes 5 and 6 are rubber compounds containing mixed SBR components, CNT-reinforced SBR and non-reinforced (virgin) SBR, as well as carbon black and other chemical components; Control formulation of non-reinforced (virgin) SBR (100) with as well as carbon black and other chemical components; Mix 7 a differently-reinforced (virgin) SBR (100) compound with carbon black and other chemical components; the composition of the text reference compound is as defined herein at Example 4.

FIG. 8: is a histogram showing the effect of CNT on hardness of SBR-carbon black-filled rubber compound in the test and reference vulcanised rubber compounds as detailed in FIG. 7.

FIG. 9: is a histogram showing the effect of CNT on M100 and M300 of SBR-carbon black-filled rubber compound in the test vulcanised rubber compounds as detailed in FIG. 7.

FIG. 10: is a histogram showing the effect of CNT on tensile strength of SBR-carbon black-filled rubber compound in the test and reference vulcanised rubber compounds as detailed in FIG. 7.

FIG. 11: is a histogram showing the effect of CNT on elongation at break (EB) of SBR-carbon black-filled rubber compound in the four test vulcanised rubber compounds as indicated in FIG. 7.

FIG. 12: is a histogram showing the effect of CNT on the resilience of SBR-carbon black-filled rubber compound in the four test and reference vulcanised rubber compounds as indicated in FIG. 7.

### EXPERIMENTAL METHODS

The various physical properties of the compositions exemplified can be measured according to any of the standard methodologies as are known in the art. For example, onset of vulcanisation can be detected via an increase in viscosity as measured with a Mooney viscometer (Vc).

These measurements can be made according to various internationally accepted standard methods ASTM 01616-07(2012) (http://www.astm.org/Standards/01646.htm). Oensity (specific gravity), elasticity (M100, M300) and tensile strength as measurable according to ASTM 0412-06ae2 (http://www.astm.org/Standards/0412.htm), or http://info.admet.com/specifications/bid/34241/ASTM-0412-Tensile-Strength-Properties-of Rubber-and-Elastomers. Elongation at break (EB) as measurable by the method described in http://www.scribd.com/doc/42956316/Rubber-Testing or in http://harboro.eo.uk/measurement of rubber properties.html where alternative methods for measurement of tensile strength, are also provided. Hardness (International Rubber Hardness Degree, IRHO), as measured according to ASTM 01415-06(2012) (http://www.astm.org/Standards/D1415.htm).

According to an alternative embodiment there is additionally provided a method of making a nanocarbon-reinforced SBR masterbatch composition wherein the method comprises the following steps:
(i) providing a dispersion of nanocarbon in a aqueous medium, wherein the aqueous medium optionally comprises one or more surfactants;
(ii) providing a styrene butadiene rubber latex, (SBR latex);
(iii) combining the styrene butadiene rubber latex, (SBR latex) with the aqueous dispersion of nanocarbon to provide a liquid composition;
(iv) mixing on a 2-roll mill or in an internal mixer to provide a nanocarbon-reinforced SBR masterbatch;
(v) addition of one or more optional masticating agents and mastication in SBR-latex-containing stage (ii) or (iii);
   wherein the nanocarbon is not subjected to an acid treatment before incorporation into the composition, and wherein the nanocarbon-reinforced SBR masterbatch composition comprises less than 5 pphr of nanocarbon, relative amount in parts by weight per hundred parts by weight of SBR.

The present invention is illustrated by the following examples, which are not intended to limit the invention. Whilst specific embodiment of one or more aspects of the present invention have been described in the Examples hereinafter, it will be appreciated that departures from the described embodiments, which incorporate yet further features or aspects as detailed hereinbefore will fall within the scope of the present invention. For example, use of alternative nanocarbon or carbon black reinforcing agents, and/or alternative virgin SBR may be used.

### EXAMPLES

The nanocarbon used in the examples consisted of carbon nanotubes having a length of <50 μm and an outer diameter of <20 nm; it had a C-purity of >85% and non-detectable free amorphous carbon. In the examples according to the invention the CNTs were employed as supplied, i.e. without acid pre-treatment. In that state the CNTs were present as agglomerated bundles of CNTs with average dimensions of 0.05 to 1.5 mm.

All percentages stated in the examples are by weight unless stated otherwise. As is common in the field of rubber technology, “pphr” stands for parts per hundred parts of rubber, and where specified relates to reinforced SBR rubber (in a nanocarbon-reinforced SBR masterbatch composition), or to total rubber component level, reinforced SBR, virgin SBR and/or natural rubber (in a reinforced rubber composition or rubber compound).

Where appropriate commercial sources for the materials utilized are provided. For standard chemicals such as for example the vulcanizing agent, sulfur any suitable commercially available source may be used.

### Example 1

### 1.1 Preparation of Nanocarbon Slurry and Nanocarbon Dispersion

A 3% nanocarbon dispersion was prepared from 15 g of nanocarbon, 75 g of surfactant and 410 g of distilled water as shown in Table 1.

TABLE 1
Preparation of 3% CNT dispersion

| | Pphr (vs aqueous | Total weight |
|---|---|---|
| Ingredients | dispersion) | (g) |
| Nancarbon, CNT | 3 | 15 |
| (C-100*) | | |
| 20% Surfactant, | 15 | 75 |
| K laurate** | | |
| Distilled water | 82 | 410 |
| Total | | 500 |

*CNTs having a length of <50 μm and outer diameter of <20 nm, a C-purity of >85% and nondetectable, Graphistrength ® C100 CNTs from Arkema lnc. King of Prussia, PA19406 USA.
**SC-215871 from Santa Cruz Biotechnology lnc. California 95060, USA

The nanocarbon, surfactant and water were placed in a suitable container, such as for example a glass beaker, and the resultant mixture was stirred by means of mechanical stirrer at 80 rpm for about 10 minutes to obtain an aqueous nanocarbon-containing slurry. The slurry was transferred to a ball mill for grinding to break down any agglomerates of nanocarbon. Ball milling was carried out for 24 hours and a nanocarbon dispersion was obtained. The dispersion was then transferred into a plastic container and the pH of the dispersion was adjusted to that of the SBR latex to which it was to be added. In this case the pH of the CNT dispersion was adjusted to between pH 8.0 and pH 10.0 by the addition of potassium hydroxide (KOH).

### 1.2. Preparation of Nanocarbon-Containing SBR Rubber Master Batches

The nanocarbon dispersion, from Example 1.1, was added to an SBR latex in a suitable container, such as for example a glass beaker. The SBR latex was used at 45% concentration without further dilution. In further experiments the Applicant has found that the SBR latex may be diluted to 30% if thickening occurs during mixing. The mixing of the SBR with the nanocarbon dispersion was then done in the presence of about 5 pphr of surfactant, where the surfactant was provided as a 5% to 20% solution as shown in Table 2.

TABLE 2
Preparation of 3 pphr CNT-SBR masterbatch
from 3% CNT (C-100) dispersion

| | | | Total |
|---|---|---|---|
| | Pphr | Wet weight | wet weight |
| Ingredients | (vs SBR) | (g) | (g) |
| 3% nanocarbon, | 3 | 100 | 300 |
| CNT, C-100 | | | |
| 10% Surfactant, | 5 | 50 | 150 |
| K laurate | | | |
| 40.5% SBR | 100 | 222.2 | 666.6 |
| latex* | | | |
| Total | | 372.2 | 1116.6 |

*cold polymerized emulsion SBR (E-SBR) having 40.5% styrene polymer, Nipol LX110, obtained from Zeon Corporation, Division of Synthetic Latex, Shin Marunouchi Center Bldg., 1-6-2 Marunouchi, Chiyoda-ku, Tokyo 100-8246, Japan.

The nanocarbon dispersion and the surfactant used were the same as detailed in Example 1 were discharged into a suitable container containing the SBR latex. The mixture was subjected to mechanical stirring for 60 minutes at stirring speed of from 80 to 100 rpm at a temperature of from 23 to 30° C.

The SBR latex filled with CNT was then coagulated using 500 ml of calcium chloride at a concentration level of 20% w/w for each 500 ml of the CNT-filled SBR latex. For the avoidance of doubt alternative suitable coagulants such as sulfuric acid (40-70% concentration), calcium nitrate (15-25% w/w concentration), and/or calcium chloride (15-20% w/w concentration); and/or mixtures thereof can be used. The coagulum formed was washed with water and squeezed to remove excess surfactants and water. The coagulum was further soaked in water overnight.

The following day, the coagulum was cut into small granules and washed with water. These granules were then dried in an electrically heated oven at from 50-80° C. until they were fully dried to provide a nanocarbon-reinforced SBR rubber masterbatch in accordance with an aspect of the present invention.

### 1.3. Preparation of Rubber Compound and Evaluation of Physical Properties of CNT-SBR Vulcanizate

Four test compositions were prepared and their physical properties prior to vulcanization and post-vulcanization were measured.

Rubber compounds according to one aspect of the invention, were prepared by mixing a CNT-reinforced SBR component, from the masterbatch products of Example 1.2, with a vulcanization agent (sulfur), a vulcanizing delayed accelerator (TBBS), and vulcanization activating agents (zinc oxide and stearic acid) by using a 2-roll mill, alternatively the compounds have also been prepared using a laboratory internal mixer. The full formulations are shown in Table 3. The cure characteristics of the compounded rubbers were determined by using a curemeter at 150° C. Various test-pieces were prepared by compression molding, and vulcanized to provide rubber compositions at an optimum state of cure at 150° C.

Table 3 illustrates the four compounds tested, Mixes 1 and 2 being based on virgin (nonreinforced/un-filled) SBR, and mixes 3 and 4 being based on CNT-reinforced SBR from the masterbatch of Example 1.2. Each test mix contains an SBR component, carbon black and further chemical components. For the avoidance of doubt the remaining chemical components in the formulations are included at the same relative levels across all four mixes, as expressed versus 100 pphr virgin SBR (in Mixes 1 and 2) and CNT-reinforced SBR (in Mixes 3 and 4). The CNT-reinforced SBR component of Mix 4 was mechanically masticated in the presence of zinc soaps of unsaturated fatty acids as processing agents and provided as Struktol WB16 at a level of 5 pphr, available from Struktol and as discussed hereinbefore. Up to 1 Opphr Struktol WB16 can be used.

Table 3, part A) illustrates the properties of the un-vulcanized rubber compositions, and Table 3, part B) illustrates the properties of the vulcanized rubber compositions.

TABLE 3
Test Compositions Mixes 1 to 4 of rubber formulations

| | Mix no | | | |
|---|---|---|---|---|
| Ingredients | 1 | 2 | 3 | 4 |
| Virgin SBR (1502)* | 100 | 100 | — | — |
| CNT-reinforced SBR (from | — | — | 103 | 103 |
| masterbatch of Ex. 1.2) | | | | |
| Vulcanizing activting agent, | 3 | 3 | 2 | 3 |
| Zinc oxide | | | | |
| Vulcanizing activting agent, | 2 | 2 | 1 | 2 |
| Stearic acid | | | | |
| Antioxidant, 6PPD | 1 | 1 | 1 | 1 |
| Carbon Black, ISAF black | — | 3 | — | — |
| (N220) from Yucheng Jinhe | | | | |
| Industrial Co. | | | | |
| Vulcanizing delayed | 1.4 | 1.4 | 1.4 | 1.4 |
| accelerator, TBBS | | | | |
| Vulcanization agent, | 1.5 | 1.5 | 1.5 | 1.5 |
| Sulfur | | | | |

A) Properties of un-vulcanized rubber compounds

| | | | | |
|---|---|---|---|---|
| V_{c}(M_{L} 1 + 4, 100° C.) | 37.7 | 41.8 | 146.8 | 69.7 |

Cure characteristics MDR 2000 (arc 0.5°) at 150° C.

| | | | | |
|---|---|---|---|---|
| Scorch time, t2 | 16.78 | 12.77 | 4.80 | 4.04 |
| Optimum cure, t95 | 39.95 | 34.68 | 16.76 | 13.01 |
| Cure time | 40 | 35 | 17 | 13 |

B) Properties of vulcanized rubber

| | | | | |
|---|---|---|---|---|
| Hardness (IRHD) | 41 | 42 | 60 | 68.2 |
| Modulus M100 (MPa) | 0.76 | 0.84 | 2.11 | 1.7 |
| Modulus M300 (MPa) | 1.38 | 1.67 | — | 5.95 |
| Tensile strength (MPa) | 1.72 | 3.21 | 6.28 | 8.3 |
| Elongation strength (EB) (%) | 373 | 462 | 256 | 387 |
| Rolling Resilience (%) | 68.5 | 68.3 | 75 | 68.2 |

*cold polymerized emulsion SBR (E-SBR) having 23.5% styrene polymer and specific gravity of 0.94, SBR Nipol 1502 obtained from Zeon Corporation, Division of Synthetic Latex, Shin Marunouchi Center Bldg., 1-6-2 Marunouchi, Chiyoda-ku, Tokyo 100-8246, Japan.

### Example 2. Evaluation of CNT Dispersion in the Rubber Matrix

### 2.1 Field Emission Scanning Electron Microscope (FESEM)

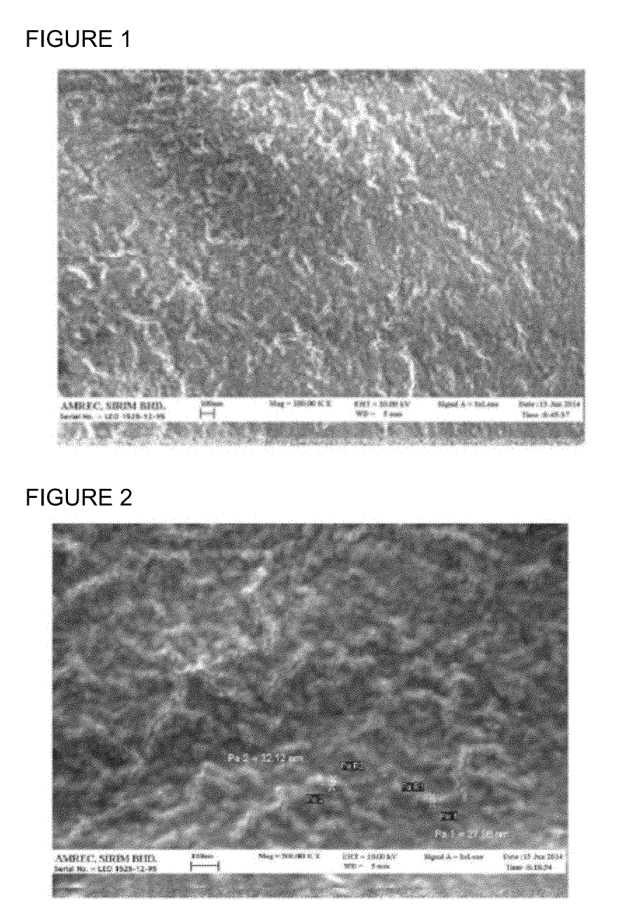

A test sample from the CNT-reinforced SBR masterbatch of Example 1.2 was placed in a container filled with liquid nitrogen for 10 minutes. Then the hard and frozen sample was crushed and one piece of the cross section surface of the sample was placed on the SEM sample stub and attached thereto with carbon tape. The sample was then sputter coated with gold particles, and was then inserted into the SEM chamber for measurement. The sample micrograph was captured using Field Emission Scanning Electron Microscope (FESEM) model LEO 1525. The results are shown in FIGS. 1 and 2 at 100×, and 200× levels of magnification respectively. In FIGS. 1 and 2 the CNT is illustrated by the lighter areas and the SBR is illustrated as the darker areas. The appearance of the lighter (CNT) areas throughout the sample show how well dispersed the CNT is within the SBR rubber matrix. In FIG. 2 the measured diameter of dispersed CNT particles Pa1 and Pa2, having diameters of and 27.98 nm and 32.12 nm respectively are illustrated.

### 2.2 Electrical Resistivity

The electrical resistivity test was also conducted as a means of assessing the CNT dispersion in the rubber matrix for a test sample from the CNT-reinforced SBR masterbatch of Example 1.2 when compared to a virgin (non-reinforced) SBR control sample. The SBR control sample is Sample 1 from Example 1.3. The electrical resistivity test was done in accordance with the standard method of BS 903: Pt. C1: 1991 & Pt. C2: 1982. The results are shown in Table 4.

TABLE 4
Results of Electrical Resistivity

| Test Parameters | Virgin SBR | CNT-reinforced SBR |
|---|---|---|
| Applied voltage, (V) | 35 | 7 |
| Surface resistivity (ohms) | 1.4 × 10¹⁵ | 7.05 × 10¹³ |
| Volume resistivity, (ohms · cm) | 1.46 × 10¹⁴ | 4.29 × 10¹³ |

It is well known that rubber is an excellent electrical insulator, and as such the very high electrical resistivity of the virgin SBR sample, as indicated by the high surface resistivity as well as its high volume resistivity, is as anticipated. In contrast, the CNT-reinforced SBR test sample demonstrated lower electrical resistivity than the virgin SBR. This confirms that presence of CNT in the SBR matrix provides an enhanced electrical path. The surface conductivity of CNT-reinforced SBR is about 700× more conductive than virgin SBR, and the bulk of CNT-reinforced SBR is about 43× more conductive than virgin SBR. The enhancement in the electrical conductivity is attributed to CNT dispersed within the SBR matrix. Both the SEM micrographs and electrical resistivity tests complement each other implying that good dispersion of CNT in the SBR matrix has been achieved.

### Example 3. Results on Mooney Viscosity, Cure Characteristics and Physical Properties

### 3.1 Effect of CNT on Mooney Viscosity

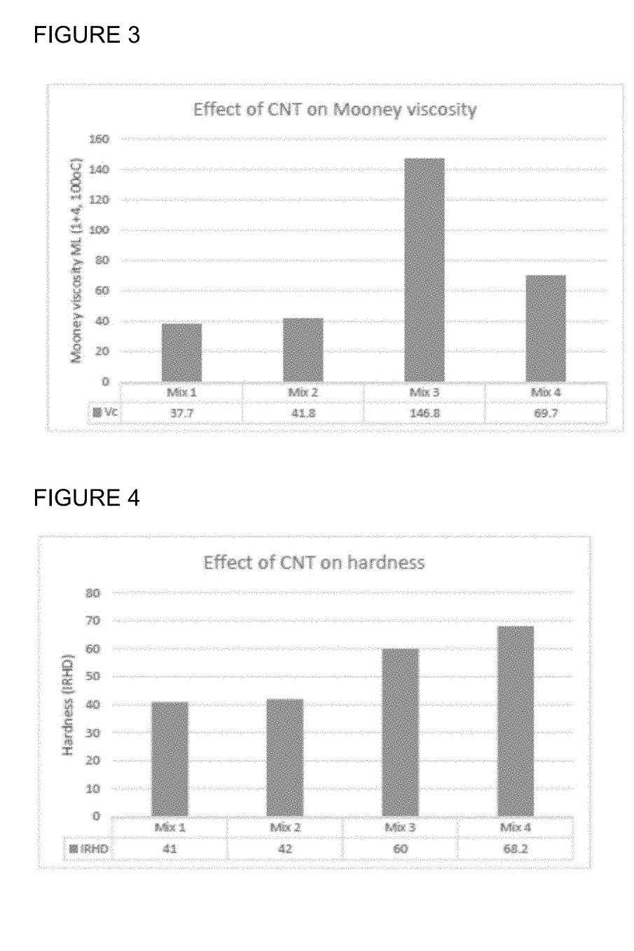

FIG. 3 is a histogram showing the effect of mechanical peptizer on Mooney viscosity, V_{c} of four different SBR masterbatches: Mix 1—gum (virgin) SBR; Mix 2—SBR+3 pphr carbon black (ISAF); Mix 3—SBR+3 pphr CNT; Mix 4—SBR+3 pphr CNT (MB pre-masticated in the presence of WB 16).

As shown by the results presented in Table 3, and as illustrated in FIG. 3, virgin SBR (Mix 1) has very low Mooney viscosity. Whilst the addition of 3 pphr carbon black (ISAF) (Mix 2) did provide a marginal increase in the viscosity, in contrast the addition of 3 pphr of CNT (Mix 3) increased the viscosity substantially. Without wishing to be bound to any particular theory it is proposed herein that this substantial increase in the viscosity is associated with enhanced interaction levels between the SBR and the nanocarbon reinforcing agent.

As high Mooney viscosities, such as that observed for Mix 3, can lead to processing difficulties, such as poor dispersion of compounding ingredients, high heat generation during mixing and poor flow, the Applicant developed an improved method for preparing CNT-reinforced SBR masterbatches which involved the addition of a processing agent, the mechanical peptizer WB16.

As also illustrated in FIG. 3, without the incorporation of mechanical peptizer, Mix 4, a CNT-reinforced SBR masterbatch gave very high Mooney viscosity. The results illustrated in FIG. 3, for this improved CNT-reinforced SBR masterbatch (Mix 4) confirm that pre-mastication with mechanical peptizer facilitated flow and provided a resultant masterbatch having reduced Mooney viscosity. Without wishing to be bound to any particular theory it is proposed herein that inclusion of the mechanical peptizer in Mix 4 facilitated flow due to provision of internal lubrication within the rubber chains, and thereby reduced viscosity of the rubber compound produced, via the presence of the fatty acid soaps.

### 3.2 Cure Characteristics

As illustrated in Table 3 and as discussed hereinbefore, the addition of nanocarbon in general, and CNT in particular to SBR results in reductions in both the scorch and cure times respectively. Care has to be taken during processing since the scorch time has reduced. However, the biggest advantage is the substantial reduction of cure time by more than 50% that would bring advantages during production since it is more economical to cure at shorter time than at longer time.

The results on mechanical properties are discussed hereinafter.

Ultimate tensile strength, or simply tensile strength, is the maximum force the rubber can withstand without fracturing when stretched, and provides an indication of how strong a rubber composition is.

Indentation hardness (IRHD) is a measurement of how resistant the material is to applied force.

Elongation at break (EB), with respect to tensile strength testing, is a measurement of how much a sample will stretch prior to break and is usually expressed as a percentage i.e. the maximum elongation.

### 3.3 Effect of CNT on Hardness

The four compositions illustrated in Table 3, Mixes 1 to 4 were vulcanised and their physical properties were compared. FIG. 4 is a histogram which illustrates the effect of mechanical peptizer on hardness. Mix 1: virgin SBR gave 41 IRHD units of hardness which is a typical value for non-reinforced vulcanized SBR rubber. Surprisingly the addition of 3 pphr (ISAF) carbon black, in Mix 2, did not produce desirable levels of SBR reinforcement, but rather provided similar levels to the virgin Mix 1, 42 vis 41 IHRD units of hardness.

On the basis of the experimental data provided herein far higher loadings of carbon black reinforcing agent would be required to increase the hardness to desirable levels, when compared to the amount of nanocarbon in the reinforced SBR compounds exemplified herein.

Advantageously, and as illustrated in the results obtained for Mixes 3 and 4, SBR reinforcement with nanocarbon, and specifically CNT at 3 pphr (relative to SBR parts per 100) in accordance with the methods herein, produces desirable levels of reinforcement as indicated by the high hardness values of 60 IRHD units and above. Of particular note is the increased hardness of Mix 4 where pre-mastication in the presence of a processing agent, and in particular a mechanical peptizer (Strucktol WB 16) would appear to have increased further the hardness by 8 points. Without wishing to be bound to any particular theory it is proposed herein that this improved hardness results from improved nanocarbon/CNT dispersion within the reinforced-SBR component, which may also be related to internal lubrication within the SBR-rubber chains associated with the fatty acid soaps.

### 3.4 Effect of CNT on M100 & M300 I Tensile Strain

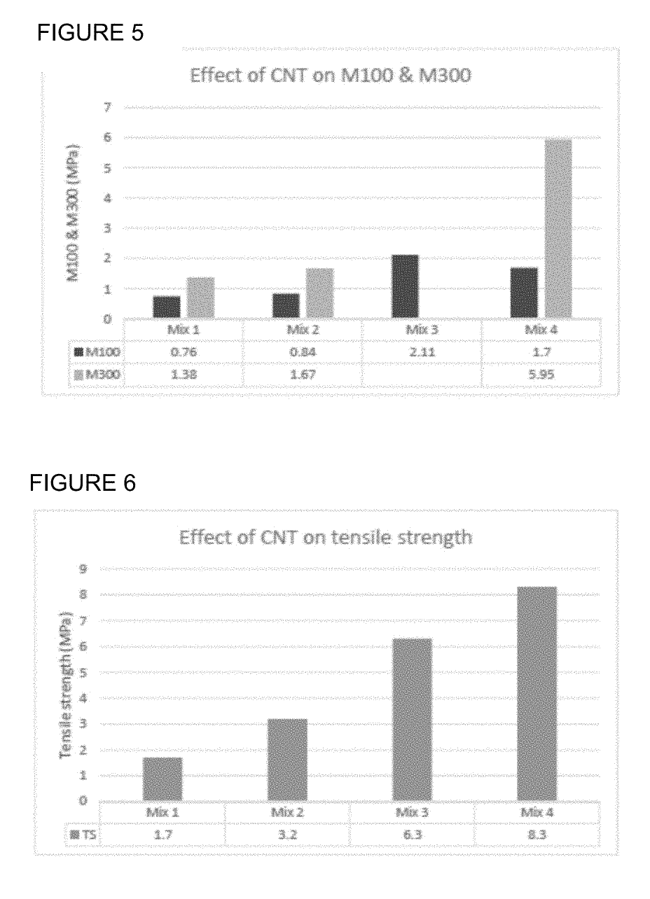

The four compositions illustrated in Table 3, Mixes 1 to 4 were vulcanised and their physical properties were compared. FIG. 5 is a histogram which illustrates the effect of mechanical peptizer on their ability to withstand tensile strain as measured by modulus, M100 and M300 for each of Mixes 1 to 4. Mix 1: virgin SBR gave typical values for non-reinforced vulcanized SBR rubber, of around 0.76 and 1.38 for M100 and M300 respectively. Once again the addition of 3 pphr of (ISAF) carbon black, in Mix 2, did not produce desirable modulus results, but once more provided levels similar to those shown by the virgin Mix 1, 0.84/1.67 for M100/M300 for Mix 2 vs 0.76 and 1.38 for Mix 1.

The results for Mixes 3 and 4 which include 3 pphr CNT as reinforcing agent in the SBR show improvements versus both Mix 1 and Mix 2. In particular, Mix 4 has >4× improved M300 and >2× improved M100 performance.

Thus it has been demonstrated that the addition of 3 pphr of CNT, as a dispersed reinforcing agent in the SBR matrix, has increased the tensile stress at 100% strain denoted as M100 by more than a factor of 2, and tensile stress at 300% strain denoted as M300 by more than a factor of 4 respectively. This provides a clear picture of the positive impact of effective dispersion of CNT as a reinforcing agent in the SBR matrix.

### 3.5 Effect of CNT on Tensile Strength

The four compositions illustrated in Table 3, Mixes 1 to 4 were vulcanised and their physical properties were compared. FIG. 6 is a histogram which illustrates the effect of mechanical peptizer on tensile strength (MPa). Mix 1: virgin vulcanised SBR is very weak having a tensile strength of only 1.7 Mpa. Whilst the addition of 3 pphr (ISAF) carbon black, in Mix 2, did produce a marginal increase in tensile strength, to 3.2 Mpa, in the context of rubber processing this is still low and is not suitable for many practical applications.

In contrast the results obtained for the nanocarbon-reinforced SBR compositions of Mixes 3 and 4 clearly demonstrate that addition of 3 pphr of CNT increased the tensile strength significantly, to 6.3 Mpa and 8.3 Mpa respectively. Such tensile strengths are especially desirable in certain applications such as industrial rubber products including hoses, belts and seals/gaskets for example.

In particular the results for Mix 4, which was pre-masticated in the presence of a mechanical peptizer demonstrated the largest improvement in tensile strength. The tensile strength of SBR-filled CNT is about a factor of 5 higher than virgin SBR (comparing Mix 4 versus Mix 1).

The results illustrated in Table 3, FIGS. 3 to 6 and as discussed at 3.3, 3.4 and 3.5 herein show the enhancement of the physical properties of vulcanised rubbers in hardness, M100, M300 and tensile strength for nanocarbon (CNT) reinforced SBR compositions as defined herein, specifically for such compositions incorporating of 3 pphr of CNT.

### Example 4: Physical Properties of CNT-SBR Black-Filled Vulcanizate

The physical properties of five further test compound formulations were investigated to determine the impact of pre-mastication with mechanical peptizer on nanocarbon-reinforced SBR masterbatches and on compositions prepared therefrom. For the avoidance of doubt the pre-mastication step in the presence of mechanical peptizer for Mixes 5 and 6 in the following experiments was carried out in accordance with the procedure discussed at Example 3.1 hereinbefore. These five further test compound formulations are shown in Table 5.

Mixes 5 and 6 are rubber compounds containing mixed SBR components, CNR-reinforced SBR (53) and non-reinforced (virgin) SBR (50), as well as carbon black (50 and 30 respectively) and other chemical components. The control formulation is non-reinforced (virgin) SBR (100) with carbon black (52) and other chemical components. Mix 7 is a further non-reinforced (virgin) SBR (100) compound with carbon black (30) and other chemical components. Mix 8 is a reference rubber compound suitable for use in tractor tyre treads and as disclosed in Tractor Tire Tread, Struktol Compounding Guide for the Rubber Industry (Revised December 1992, p 60, Struktol, Schill & Seilacher (GmbH & Co), Edision Published in December 1992 and incorporated herein by reference.

For the avoidance of doubt the remaining chemical components in the formulations are included at the same relative levels across the Control and mixed 5, 6, and 7, as expressed versus 100 pphr virgin SBR (in Control and Mix 7) and combined SBR level (103) (in Mixes 5 and 6).

Table 5, part A) illustrates the properties of the un-vulcanized rubber compositions, and Table 5, part B) illustrates the properties of the vulcanized rubber compositions

TABLE 5
Test Formulations - Mixes 5 to 7,
Control and Reference formulation

| | Mix no | | | | |
|---|---|---|---|---|---|
| Ingredients | Control | 5 | 6 | 7 | Ref. |
| SBR 1712 | — | — | — | — | 137.5 |
| Virgin SBR (1502) | 100 | 50 | 50 | 100 | — |
| CNT-reinforced SBR, from | — | 53 | 53 | — | — |
| Experiment 1.2 | | | | | |
| Masterbatch | | | | | |
| Vulcanizing activating | 3 | 3 | 3 | 3 | 3 |
| agent, Zinc oxide | | | | | |
| Vulcanizing activating | 2 | 2 | 2 | 2 | 1 |
| agent, Stearic acid | | | | | |
| Antioxidant, Santoflex | 1 | 1 | 1 | 1 | 1.5 |
| 13 (6PPD) | | | | | |
| Carbon Black, ISAF black | 52 | 50 | 30 | 30 | 60 |
| (N220) | | | | | |
| Antioxidant, poly(2,2,4- | — | — | — | — | 1 |
| trimethyl-1,2- | | | | | |
| dihydroquinoline) (TMQ)* | | | | | |
| Mineral Oil, Shellflex | 4 | 4 | 4 | 4 | — |
| 250 MB | | | | | |
| Vulcanizing delayed | 1.4 | 1.4 | 1.4 | 1.4 | — |
| accelerator, TBBS | | | | | |
| Vulcanization agent, | 1.5 | 1.5 | 1.5 | 1.5 | 2 |
| Sulfur | | | | | |
| Struktol 40 MS Flakes** | — | — | — | — | 5 |
| Stuktol A 60*** | — | — | — | — | 2 |
| Vulcanizing delayed | — | — | — | — | 0.2 |
| accelerator 2- | | | | | |
| mercaptobenzothazole | | | | | |
| (MBT) | | | | | |
| Vulcanizing delayed | — | — | — | — | 1.2 |
| accereator N-cyclohexyl- | | | | | |
| 2-bensothiazole | | | | | |
| sulfenamide (CBS) | | | | | |

A Mooney viscosity of rubber compound

| | | | | | |
|---|---|---|---|---|---|
| V_{c}(M_{L} 1 + 4, 100° C.) | 69.4 | 104 | 76.2 | 63.4 | 67 |

Cure characteristics at 150° C.

| | | | | | |
|---|---|---|---|---|---|
| Scorch time, t2 (minutes) | 5.08 | 0.07 | 5.55 | 4.3 | 8 |
| Optimum cure, t95 | 22.85 | 19.3 | 21.7 | 14.6 | N/A |
| (minutes) | | | | | |
| Cure time (minutes) | 23 | 19.5 | 22 | 15 | 15 |

B Physial properties

| | | | | | |
|---|---|---|---|---|---|
| Hardness (IRHD) | 65 | 68 | 58 | 61 | 57 |
| M100 (MPa) | 1.36 | 2.18 | 2.61 | 1.4 | — |
| M300 (MPa) | 5.3 | 11.1 | 13.4 | 4.91 | 6.3 |
| Tensile strength (MPa) | 15.3 | 21.2 | 24.5 | 22 | 19.6 |
| Elongation at break, | 528 | 459 | 478 | 738 | 600 |
| EB (%) | | | | | |
| Rolling Resistance (%) | 48.6 | 48.2 | 54.8 | 50.4 | 33 |

For the avoidance of doubt, unless specified otherwise, the materials used in the formulations of Table 5, are as indicated hereinbefore, in Table 3.
*TMQ available from Shandong Caoxian, Shandong Province, China.
**mixture of dark aromatic hydrocarbon resins available from The Struktol Company of America.
***mixture of zinc soaps of high-molecular weight fatty acids available from The Struktol Company of America.

To prepare the test nanocarbon-reinforced SBR compositions—Mixes 5 and 6, CNT-reinforced SBR, from the masterbatch of Example 1.2, was blended with virgin (non-reinforced) SBR at a ratio of about 1:1. Additional reinforcing agent, (ISAF) carbon black was also incorporated in these test nanocarbon-reinforced SBR compositions at a ratio of about 1:2 to about 2:5 relative to the total rubber content (SBR, virgin and/or CNT-reinforced SBR).

Prior to use in test compositions 5 and 6, the CNT-reinforced SBR masterbatch was subjected to pre-mastication with a processing agent/mechanical peptizer (zinc soaps of unsaturated fatty acids/Struktol WB16) for 5 minutes in a Haake laboratory internal mixer. Without wishing to be bound to any particular theory it is proposed herein that this pre-mastication process facilitates not only dispersion of the reinforcing CNT, but also the remainder of the formulation ingredients.

The conditions utilised to provide effective pre-mastication using a Haake laboratory internal mixer were: starting mixing temperature, 80° C.; rotor speed, 80 rpm.

The mastication process sequence utilised was: the SBR was added to the mixer and mixing began at 80 rpm; after about 1 minute the nanocarbon and the remaining chemical components of the formulation, with the exception of carbon black, as indicated in Table 5 for mixes 5 or 6 were added; after about 2 further minutes, the carbon black was added and a sweep was carried out; after about a further 1 minute a further sweep was carried out and after a total of 20 minutes from sequence start the pre-masticated composition was discharged from the mixer.

### 4.1 Effect of CNT on Mooney Viscosity of Black-Filled SBR Compound

The five compositions illustrated in Table 5, were vulcanised and their physical properties were compared. The control mix and Mix 5 were reinforced with 52 and 50 pphr of (ISAF) carbon black respectively. The addition of 3 pphr of CNT, in the form of CNT-reinforced SBR, was shown to increase the Mooney ML (1+4) 100° C. viscosity (Vc) markedly. In order to seek a reduction in the viscosity in the CNT-reinforced SBR rubber containing compound, the amount of (ISAF) carbon black was reduced to 30 pphr in Mix 6. This reduced the Mooney viscosity (Vc) of the CNT-reinforced SBR rubber containing compound in Mix 6 to a level (76.2) which was comparable to that for the control formulation level (69.4).

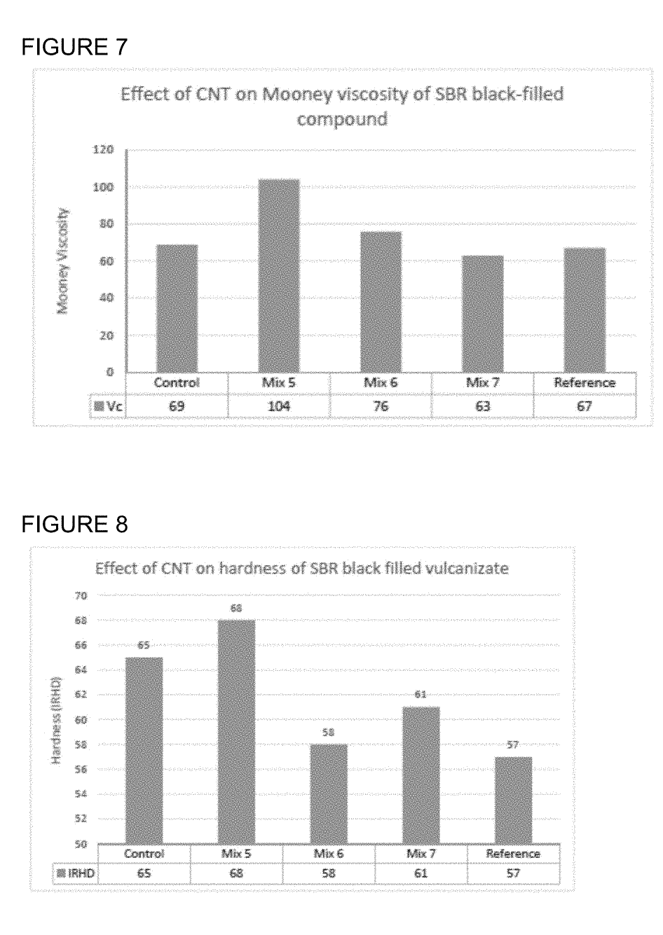

Mix 7 is an SBR compound, prepared from virgin SBR containing 30 pphr of (ISAF) carbon black. Comparing the results for Mix 6 and Mix 7, as presented in Table 3, the addition of 3 pphr of CNT was demonstrated to increase the viscosity of the compound as shown in FIG. 7. This result indicates that CNT has a far higher rubber-reinforcing agent interaction potential than carbon black. Without wishing to be bound to any particular theory it is proposed herein that this is as a consequence of its high surface area associated with the finer size of the CNT versus that of carbon black.

The increase in viscosity for Mix 6 has the additional advantages of enhancing the collapse resistance and retaining the extrudate profiles after extrusion process. However, there is a risk of high heat generation during processing with high viscosity rubber compounds which may lead to premature vulcanization (scorch). In order to reduce the viscosity of the compound, the amount of (ISAF) carbon black was reduced to 30 pphr as shown in Mix 6. This approach has been demonstrated to reduce the viscosity of the rubber compound to 76 Mooney units which is an acceptable level in practice.

### 4.2 Effect of CNT on Hardness of Black-Filled SBR Vulcanizate

The compositions illustrated in Table 5, were vulcanised and their physical properties were compared. The carbon black reinforced control compound has a hardness of 65 IRHD units, which would be anticipated for a mixture of virgin SBR: carbon black in a 2:1 ratio.

Comparing this with the hardness observed for Mix 5, the incorporation of CNT has increased the hardness by 3 points to 68 IRHD units. As shown in FIG. 8, reducing the carbon black component from 50 to 30 pphr in the CNT-reinforced SBR composition reduced the hardness to 58 IRHD units, a decrease of 10 points which is comparable to the hardness observed for the reference compound.

### 4.3 Effect of CNT on M100 & M300 of Black-Filled SBR Vulcanizate

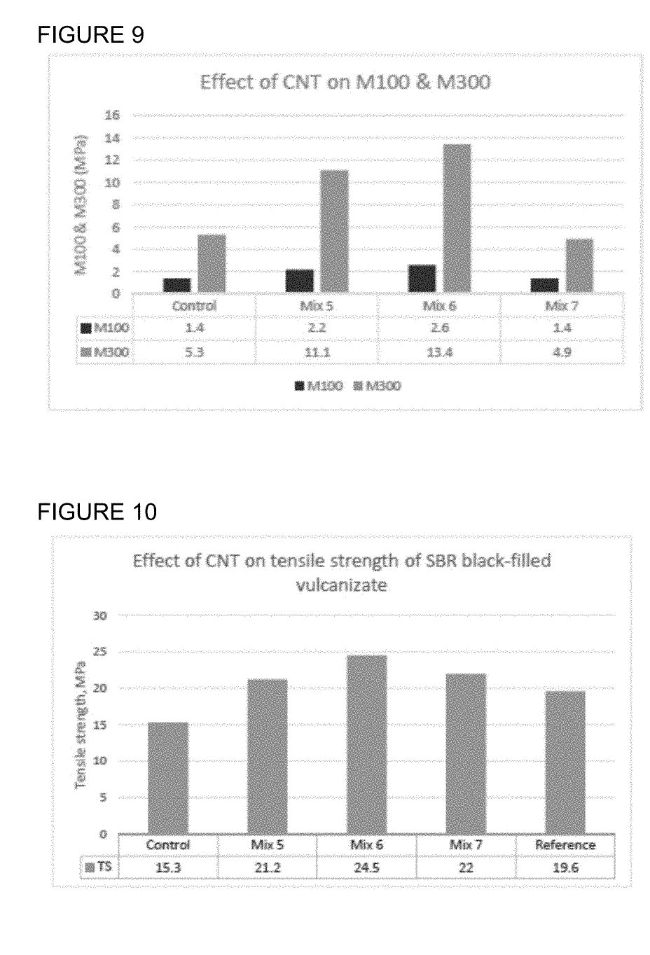

The compositions illustrated in Table 5, were vulcanised and their physical properties were compared. As shown in the results listed in Table 5 and as illustrated in FIG. 9, in contrast to the trend observed in the hardness results, Mix 6 gave overall better modulus values than the Control, the Reference compound or Mixes 5 or 7.

This is surprising because in theory, the M100 and M300 values should show follow the same trend as hardness.

As also shown in Table 5, and illustrated in FIG. 9, the incorporation of 3 pphr of CNT into the rubber compositions, as CNT-reinforced SBR, increased both M100 and M300 by a factor of about 2 against mixes without CNT. Furthermore, this advantageous higher reinforcement was attained with the incorporation of a relatively small amount of CNT.

### 4.4 Effect of CNT on Tensile Strength of Black-Filled SBR Compound

The compositions illustrated in Table 5, were vulcanised and their physical properties were compared. As shown in the results listed in Table 5 and as illustrated in FIG. 10, the incorporation of 3 pphr of CNT, as CNT-reinforced SBR, increased the tensile strength by 38.3% (when comparing the results for Mix 5 versus those for the virgin SBR control). In FIG. 10, the the extra enhancement in the mechanical strength provided by CNT is especially clear.

Reducing the level of carbon black from 50 pphr to 30 pphr increased the tensile strength of the corresponding CNT-reinforced SBR mix (Mix 6). In line with the trend observed in earlier experiments herein, and as illustrated in FIG. 8, reducing the level of carbon black was shown to decrease the hardness and allowed the rubber to fail at higher elongation and hence at high stress level.

### 4.5 Effect of CNT on Elongation at Break (EB %)

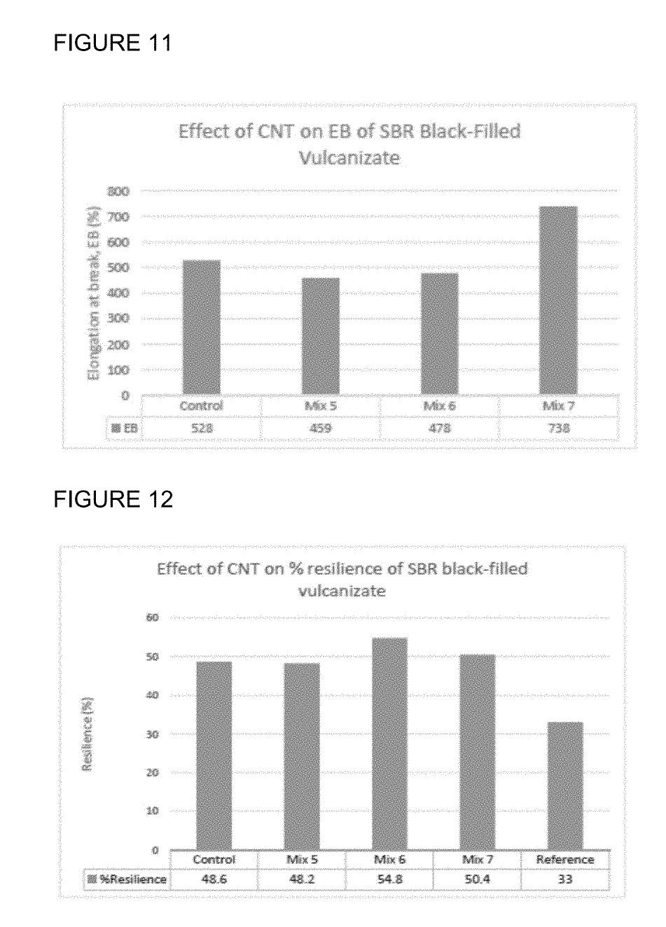

The compositions illustrated in Table 5, were vulcanised and their physical properties were compared. As shown by comparison of the results listed in Table 5 and as illustrated in FIGS. 8 and 11, the incorporation of 3 pphr of CNT, as CNT-reinforced SBR, in Mixes 5 and 6 provided increases in tensile strength alongside desirable elongations.

### 4.6 Effect of CNT on Resilience of SBR Black-Filled Vulcanizate

The compositions illustrated in Table 5, were vulcanised and their physical properties were compared. As shown in the results listed in Table 5 and as illustrated in FIG. 12, the highest rolling resilience was observed for a rubber composition reinforced with 3 pphr of CNT, from CNT-reinforced SBR, and reinforced with a further 30 pphr of (ISAF) carbon black (Mix 6).

This demonstrates the advantageous improvement in resilience of SBR delivered by effective incorporation/dispersion of small amounts of CNT into the SBR matrix. A key advantage of such improved, higher resilience for SBR rubbers relates to their potential for use in automotive or truck tires, and in particular for providing tires which have reduced capacity for reduces heat generation and thereby providing desirable low rolling resistances. These two properties are the main requirements for the manufacturing of “green tire”.

It is proposed that the desirable, high resilience for the nanocarbon containing reinforced SBR rubber compounds are also associated with use of lower amounts of carbon black (ISAF) than have previously been possible for reinforced SBRs for utility in tires. Advantageously, the reduction in carbon black loading in Mix 6 produces lighter weight tires, which is desirable for the delivery of improvements (reductions) in oil consumption levels than heavy weight tires.

The results obtained in Experiments 1, 2, 3 and 4, and as illustrated in FIGS. 1 to 12 demonstrate that CNT SBR masterbatch filled with 30 pphr of ISAF gives better overall physical properties and higher mechanical strengths than that filled with 50 pphr ISAF, that CNT SBR masterbatch treated with mechanical peptizer gives higher mechanical strength and better physical properties than untreated CNT SBR masterbatch, and that a highly desirable combination of properties, viscosity, hardness, elongation at break, low rolling resistance and is provided by rubber compounds prepared from the nanomaterial-reinforced SBR masterbatches according to the present invention, and particularly where such masterbatches are premasticated in the presence of mechanical peptizer prior to use in the preparation of said rubber compounds.

### Experiment 5: Assessment of Activated Versus Non-Activated Nanocarbon

As detailed hereinbefore, the present invention provides a method for the preparation of nanocarbon reinforced SBR masterbatches, and in particular CNT reinforced SBR masterbatches from SBR latex, and to use of such reinforced SBR in rubber compounds.

Chinese patent application CN 1663991 A used acid treatment to make CNTs hydrophilic before mixing them with a NR latex. The Applicants have demonstrated that without treating the CNT with the acid solution, the physical properties of the vulcanized natural rubber filled with untreated (virgin) CNT are better than acid treated CNT. The results of this experiment are directly applicable to the present invention because they show that acid-activation of CNT is not a pre-requisite for performance enhancement in reinforced rubber compositions per se.

### 5.1 Preparation of Activated CNT Dispersion and Masterbatch

Activated CNT (C-100) was prepared in accordance with the method reported in CN 1663991 A. In our experiment, the CNT used was C-100. The acid solution mixture was prepared by mixing dilute sulfuric acid (5% concentration) with dilute nitric acid (5% concentration) in the required ratio of 3:1.

In the process of CN 1663991 A, 1 g of CNTs corresponds to 10 ml of acid solution. In our experiment, 12 g of CNT (C-100) was used and mixed with 120 g of acid solution [90 g of sulfuric acid (5% concentration) and 30 g of nitric acid (5% concentration)]. The mixture was boiled at 70° C. for 30 min on an electrically heated plate. The mixture was allowed to cool before filtering the using a funnel and filter paper. The acid-treated CNT so-collected was rinsed with distilled water and the acid-treated, activated CNT was then dried in an oven at 60° C. overnight.

### 5.2 Preparation of 2% Acid Treated CNT (C-100) Slurry

Table 6 shows the formulation to produce 2% acid treated CNT slurry. Each ingredient was weighed accurately by using an electrical weighing balance. The coarse slurry was prepared by mixing all the ingredients shown in Table 6 in a suitable glass beaker. The mixture was stirred slowly by means of mechanical stirrer at 80 rpm for about 10 minutes before transferring into a ball mill for grinding process to breakdown any agglomeration or aggregation of CNT. The mixtures were ball milled for 24 h. At the end of the milling process, the slurry was transferred into a plastic container.

TABLE 6
Formulation of 2% treated C-100 slurry

| | Dry wt | Wet wt |
|---|---|---|
| Ingredients | (g) | (g) |
| Nanocarbon, C-100 (treated) | 2 | 12 |
| Surfactant, 10% K laurate | 10 | 60 |
| Water | 88 | 528 |
| Total | 100 | 600 |

The slurry so-obtained was ready for use to prepare an acid treated CNT NR masterbatch from NR concentrated latex and the formulation of this masterbatch is shown in Table 7.

TABLE 7
Formulation to produce 2 pphr acid treated CNT NR MB

| | Dry wt | Wet wt |
|---|---|---|
| Ingredients | (g) | (g) |
| Nanocarbon, 2% treated | 2 | 100 |
| C-100 (K laurate) | | |
| Surfactant, 10% K laurate | 5 | 50 |
| Rubber, 30% HA latex | 100 | 333.3 |
| Total | | 483.3 |

Each ingredient was weighed accurately by using an electrical weighing balance. The ingredients were mixed by stirring at rotational speed of 80 rpm for 30-45 minutes. The latex mix was then coagulated with acetic acid. The coagulum was then washed and soaked in tap water overnight for the leaching process. After the leaching process, the coagulum was cut into small sizes to increase its surface area to shorten the drying time. Drying was done in an electrically heated oven at 45° C. The dry weight was monitored until it was relatively constant.

### 5.3 Preparation of Rubber Compound Using Acid Treated CNT NR Masterbatch

Table 8 shows the compound formulations for both untreated (virgin) CNT NR masterbatch and that of acid treated CNT NR masterbatch. The mixes were prepared by mixing on a 2-roll mill at 50° C. for about 10 minutes total mixing time, with frequent cutting and folding of the rubber band during mixing process to ensure uniform mixing and good quality finalized mix. The finalized mixes were stored for 16 hours before molding the test-pieces.

Moulding of test-pieces was done by using appropriate compression molds compressed between electrically heated platens. The temperature of vulcanization was at 150° C. and cured to optimum state of cure (t95).

TABLE 8
Compound formulation

| Ingredients | Pphr | pphr |
|---|---|---|
| CNT Latex MB | 102 | — |
| Surface activated CNT Latex | — | 102 |
| MB | | |
| Vulcanizing activating agent, | 3 | 3 |
| ZnO | | |
| Vulcanizing activating agent, | 2 | 2 |
| Stearic acid | | |
| Antioxidant, Santoflex 13 | 1 | 1 |
| (6PPD) | | |
| Vulcanizing agent, Sulphur | 1.5 | 1.5 |
| Vulcanizing delayed | 1.4 | 1.4 |
| accelerator, TBBS | | |

Rheology and cure characteristics

| | | |
|---|---|---|
| Mooney viscosity (MU) | 20 | 20.6 |
| Cure characteristics at 150° C. | | |
| t₂ (minutes) | 6.4 | 5.8 |
| t₉₅ (minutes) | 16.0 | 18 |

Physical Properties

| | | |
|---|---|---|
| Hardness (IRHD) | 48 | 46 |
| M100 (MPa) | 1.14 | 1.11 |
| M300 (MPa) | 3.10 | 3.07 |
| Tensile Stress (Mpa) | 26.1 | 19.99 |
| Elongation at Break, EB (%) | 612 | 614 |

### Physical Tests

1. Mooney viscosity (ISO/R289)—QC Tests on unvulcanized rubber compounds.
2. Cure characteristics (1803417)—QC Tests on unvulcanized rubber compounds.
3. Hardness (ISO 48)—QC Tests on vulcanized rubber compounds.
4. Tensile strength, EB and M100, M300 (18037)—QC Tests on vulcanized rubber compounds.

### Results and Discussions

Table 8 shows the physical properties of both unvulcanized rubber and vulcanized rubber. There is no significant difference between the Mooney viscosity of treated and untreated CNT NR masterbatch as shown in Table 8. However, the cure time (t95) of the treated CNT NR masterbatch was slightly longer than untreated NR masterbatch. This is expected because the presence of acid retards cure.

The hardness of untreated CNT vulcanized rubber was higher by 2 points than acid treated CNT vulcanized rubber. The tensile strength and moduli M100 and M300 (stress at 100% and 300% strain) of untreated CNT vulcanized rubber were higher than that of acid treated CNT vulcanized rubber. The non-activated CNT gave overall better performance than activated CNT.

1. A nanocarbon-reinforced styrene-butadiene rubber (SBR) masterbatch composition comprising less than 5 pphr (parts by weight per hundred parts by weight of SBR) of nanocarbon, wherein the nanocarbon has not been subjected to an acid treatment before incorporation into the SBR, wherein the composition is a liquid composition obtained by combining a liquid dispersion of the nanocarbon and liquid SBR in the form of a latex, and wherein the combined nanocarbon dispersion and SBR latex mixture is masticated.

2. A nanocarbon-reinforced styrene-butadiene rubber (SBR) masterbatch composition comprising from 0.5 to 4.5 pphr (parts by weight per hundred parts by weight of SBR) of nanocarbon, wherein the nanocarbon has not been subjected to an acid treatment before incorporation into the SBR, wherein the composition is a liquid composition obtained by combining a liquid dispersion of the nanocarbon and SBR in the form of a latex, and wherein the combined nanocarbon dispersion and SBR latex mixture is masticated.

3. The composition according to claim 1 wherein the nanocarbon is present as carbon nanotubes (CNT), and as CNTs having a length of less than 50 μm and/or an outer diameter of less than 20 nm.

4. The composition according to claim 1 wherein the SBR is E-SBR.

5. The composition according to claim 1 wherein the nanocarbon comprises from 0.5 to 4.0, pphr nanocarbon per 100 parts by weight of SBR.

6. The composition according to claim 1 wherein the SBR is in the form of a latex having a solid content of from 40% to 50%.

7. The composition according to claim 1 wherein the SBR is in the form of a latex having a total solid content of 45%, and a pH of 8.0, specific gravity of 1.0 and a boiling point of 100° C.

8. The composition according to claim 1 wherein the composition is masticated either before or after the addition of the aqueous nanocarbon dispersion to the SBR latex.

9. The SBR composition according to claim 1 wherein the mastication is mechanical mastication in the presence of one or more masticating agents, and optionally one or more chemical plasticizers, one or more nonionic dispersing agents, one or more homogenizing agents and mixtures and combinations thereof.

10. The SBR composition according to claim 8 wherein the mastication agent is one or more peptizing agents each independently present at a level of from 0.1 to 0.3 pphr.

11. A method of making a liquid nanocarbon-reinforced SBR masterbatch composition comprising:
(i) providing a dispersion of nanocarbon in an aqueous medium, wherein the aqueous medium optionally comprises one or more surfactants;
(ii) combining the dispersion of nanocarbon to a styrene butadiene rubber latex, (SBR latex);
(iii) mixing on a 2-roll mill or in an internal mixer to provide a nanocarbon-reinforced SBR masterbatch;
(iv) addition of one or more optional masticating agents and mastication in SBR latex-containing stage (ii) or (iii);
wherein the nanocarbon is not subjected to an acid treatment before incorporation into the composition, and wherein the nanocarbon-reinforced SBR masterbatch composition comprises less than 5 pphr of nanocarbon relative amount in parts by weight per hundred parts by weight of SBR.

12. The method according to claim 11 wherein the pH of the nanocarbon dispersion and/or of the SBR latex is/are adjusted so that the difference between the pH values of the two components is less than 2 pH units.

13. The method according to claim 12 wherein the pH of the adjusted SBR latex is between pH 8.0 and pH 10.0.

14. The method according to claim 12 wherein the nanocarbon is carbon nanotubes (CNT) and wherein the SBR is E-SBR.

15. The method according to claim 11 wherein the concentration of the nanocarbon in the nanocarbon dispersion is from 1% to 5% by weight of the aqueous dispersion.

16. The method according to claim 11 wherein total level of surfactant present is from 5% to 20% by weight of the added aqueous component.

17. The method according to claim 11 wherein the composition is a dry composition obtained by coagulating the masticated liquid nanocarbon filled SBR latex composition and drying the coagulate.

18. The method according to claim 17 wherein the coagulants are independently selected from aqueous solutions of: calcium chloride; calcium nitrate; sulphuric acid; and mixtures thereof.

19. The method according to claim 17 wherein the coagulants are independently selected from aqueous solutions of: calcium chloride at 20% aqueous concentration; calcium nitrate at from 15% to 25% aqueous concentration; dilute sulphuric acid at from 40% to 70% concentration; and mixtures thereof.

20. A nanocarbon-reinforced styrene-butadiene rubber (SBR) composition comprising a mixture of rubber components, nanocarbon, and carbon black wherein the rubber components comprise nanocarbon-reinforced SBR, and one or more additional nonreinforced (virgin) rubber components, wherein the relative amount in parts by weight per hundred parts by weight of nanocarbon-reinforced SBR to non-reinforced (virgin) rubber is in the range of from 4:5 to 5:4 and wherein the relative amounts in parts by weight per hundred parts by weight of nanocarbon to carbon black is in the range of: 1:100 to 1:9, wherein the relative amount of nanocarbon to total rubber is in the range of: 0.5:100 to 4.5:100, wherein the nanocarbon component is pre-dispersed within the nanocarbon-reinforced SBR component, wherein the nanocarbon has not been subjected to an acid treatment before incorporation into the reinforced SBR component of the composition, and wherein the composition optionally includes: one or more curing agents; one or more activators; one or more delayed-accelerators; one or more antioxidants; one or more processing oils; one or more waxes; one or more scorch inhibiting agents; one or more processing aids; one or more tackifying resins; one or more reinforcing resins; one or more peptizers, and mixtures thereof.

21. The nanocarbon-reinforced SBR composition according to claim 20 wherein the relative amounts in parts by weight per hundred parts by weight of nanocarbon to carbon black is in the range of from: 1:50 to 1:7.

22. The nanocarbon-reinforced SBR composition according to claim 20 wherein the relative amounts in parts by weight per hundred parts by weight nanocarbon to total rubber is in the range of from: 1:100 to 1:25.

23. The nanocarbon-reinforced SBR composition according to claim 20 wherein the SBR component containing the nanocarbon contains from 0.5 to 4.5 pphr nanocarbon.

24. The nanocarbon-reinforced SBR composition according to claim 20 wherein the additional rubber component is one or more natural sourced rubber components, one or more synthetic rubber components, or a mixture or combination thereof.

25. The nanocarbon-reinforced SBR composition according to claim 20 wherein the additional rubber component is one or more synthetic rubbers, and optionally non-reinforced (virgin) E-SBR.

26. The reinforced SBR composition according to claim 20 wherein carbon black is present at a level of from 10 to 50 pphr by weight versus 100 parts of the rubber present.

27. The SBR composition according to claim 20 containing a vulcanizing agent a level of from 1 pphr to 4 pphr.

28. The SBR composition according to claim 20 containing one or more vulcanizing delaying accelerators at individual levels of from 1.5 pphr to 8 pphr.

29. The SBR composition according to claim 20 containing one or more vulcanizing activating agents each at a level of from 0.5 pphr to 4 pphr.

30. The SBR composition according to claim 20 containing one or more antioxidants each at a level of from 0.5 pphr to 5 pphr.

31. The SBR composition according to claim 20 containing one or more mineral oils each at a level of from 2 pphr to 6 pphr.

32. The reinforced SBR composition according to claim 20 for use in the manufacture of one or more articles independently selected from: car or light truck tires; truck tire tread compounds; automotive floor mats; brake and clutch pads; footwear such as soles and heels for footwear; domestic and commercial products including floor mats, conveyor belts, garden and industrial hosing, insulation and jacketing for electrical cables; use in foodstuffs including food packaging.
